(19) United States
(12) Patent Application Publication
(10) Pub. No.: US 2018/0120128 A1
(43) Pub. Date: May 3, 2018

(54) METHOD AND STRUCTURE FOR POSITION DETECTION

(71) Applicant: Yoav Neuman, Plano, TX (US)

(72) Inventor: Yoav Neuman, Plano, TX (US)

(21) Appl. No.: 15/717,895

(22) Filed: Sep. 27, 2017

Related U.S. Application Data
(63) Continuation-in-part of application No. 15/490,837, filed on Apr. 18, 2017, now abandoned.
(60) Provisional application No. 62/324,324, filed on Apr. 18, 2016.

(51) Int. Cl. G01D 5/02; G01S 1/76

(52) U.S. Cl. CPC G01D 5/02; G01S 1/76

(57) ABSTRACT

A method and structure are disclosed for simultaneous detection of the relative positions between first and second members of each joint in a multiplicity of joints in a system. In the multiplicity of joints, as the relative positions between the first and second members of a joint change, a position-sensitive vibration source associated with that joint generates a vibration signal with a characteristic frequency spectrum. Vibration signals from the multiplicity of joints combine into a mixed vibration signal. This mixed vibration signal is detected and separated into individual characteristic frequency spectra by a vibration-detecting device to enable simultaneous monitoring of the positions of each of the joints in the multiplicity of j oints. Joints may be rotary, linear, or a combination of joint types.

This application is a continuation-in-part of U.S. patent application Ser. No. 15/490,837, filed Apr. 18, 2017, which claims priority from U.S. Prov. Pat. App. 62/324,324, file Apr. 18, 2016, both of which are hereby incorporated by reference.

### TECHNICAL FIELD

The present invention relates to methods and systems for measuring positions, and more specifically to methods and systems for determining the relative positions of two members of a joint.

### BACKGROUND

Many types of devices comprise one or more members that move relative to each other in a pre-defined way, such as rotation, or linear motion. Often it would be useful, or necessary, to detect the relative positions of these members, for example, to facilitate control of the motion of the joint and/or to display the motion of the joint to an operator. Various methods for detecting positions of members of joints may include encoders or interferometers, all of which may be expensive, difficult to implement, and possibly susceptible to environmental degradation or damage in applications. The motion (i.e., the change in relative positions of members of a joint) may be characterized by one or more degrees of freedom. For example, in a rotary joint, a first degree of freedom may be motion in a clockwise direction, a second degree of freedom may be motion in a counterclockwise direction, and a third degree of motion may be a home position (e.g., the joint is at a certain rotational position) sensor. Thus, for a system with N separate joints, there may be up to 3N or more degrees of freedom. In the disclosure herein, each of these possible degrees of freedom may have a separate position detector, functioning independently and simultaneously with relative motions of the first and second members of the separate joints.

For example, U.S. Pat. No. 9,121,927 describes an encoder that uses multiple reeds that are caused to vibrate by intermittent contact with a contacting portion on a rotating shaft. As the reeds are contacted, they are excited to vibrate, and each reed is tuned to a characteristic unique frequency. By detection of these unique frequencies, a sound processor can determine which reeds are ringing at any one time, thereby determining the absolute rotary position of the shaft. To achieve good angular resolution of the shaft position, a substantial number of reeds are required (for example to get 10° angular resolution would require 36 reeds). Limitations of signal processing then limit the number of shafts which can be monitored simultaneously.

There is great current interest in the “Internet of Things” (TOT) in which real devices (household appliances and functions such as heat and air conditioning, automobile accessories, etc.) may be monitored and controlled remotely. Clearly a simple, inexpensive, and reliable means for position detection could be of great value in enabling the TOT.

Thus, for a wide range of applications, there is a need for less-expensive and more robust means for detecting the relative positions of members of joints.

### SUMMARY

An object of the invention is to provide a position encoder that can be used in a variety of applications.

In embodiments, one or more joints in a multiplicity of one or more joints may be configured with a position-sensitive vibration source (PSVS). Each PSVS generates a vibration signal (e.g., sound in air and/or vibrations in a solid structure) with a characteristic and unique (i.e., different from the frequency spectra of all other PSVSs) frequency spectrum (which in some embodiments may combine a multiplicity of different frequencies) when the first and second members of the joint corresponding to that PSVS move relative to each other. This vibration signal may indicate the relative or absolute position of a joint, which may be rotary, linear, or some other type of joint. This vibration signal may be detected using a vibration-detecting device (VDD). Commonly-available VDDs include smart phones or computers (tablet, laptop, or desktop). Results from the processed vibration signals may then be displayed.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the scope of the invention as set forth in the appended claims.

### BRIEF DESCRIPTION OF THE DRAWINGS

For a more thorough understanding of the present disclosure, and advantages thereof, reference is now made to the following descriptions taken in conjunction with the accompanying drawings, in which:

FIG. 1 shows three views of an embodiment, each view illustrating a different angular position around a rotary joint;

FIG. 2 shows a frequency spectrum and frequency passbands for multiple bandpass filters;

FIG. 3 shows a vibration signal and an output signal from a first signal detector for a first degree of freedom in an embodiment moving at a constant first speed;

FIG. 4 shows a vibration signal and an output signal from the first signal detector for the first degree of freedom for the embodiment in FIG. 3 moving at a constant second speed;

FIG. 5 shows a vibration signal and an output signal from a second signal detector for a second degree of freedom in the embodiment of FIG. 3 moving at a constant first speed;

FIG. 6 shows a vibration signal and an output signal from the second signal detector for the second degree of freedom for the embodiment in FIG. 3 moving at a constant second speed;

FIG. 7 shows a vibration signal and an output signal from the second signal detector for the second degree of freedom in the embodiment of FIG. 3 moving at a decreasing speed;

FIG. 8 shows a vibration signal and an output signal from the second signal detector for the second degree of freedom in the embodiment of FIG. 3 moving at an increasing speed;

FIG. 9 shows an embodiment for a rotary joint;

FIG. 10 shows vibration signals and output signals from signal detectors for an embodiment, moving in a first direction;

FIG. 11 shows vibration signals and output signals from signal detectors for the embodiment of FIG. 10, moving in a direction opposite to the first direction;

FIG. 12 shows an embodiment for a rotary joint;

FIG. 13 shows a cross-sectional view of the embodiment in FIG. 12;

FIG. 14 shows vibration signals and output signals from signal detectors for an embodiment, moving in a first direction;

FIG. 15 shows vibration signals and output signals from signal detectors for the embodiment of FIG. 14, moving in a direction opposite to the first direction;

FIG. 16 shows an embodiment for a linear joint;

FIG. 17 shows cross-sectional views of the embodiment in FIG. 16;

FIG. 18 shows a diagram of a position detection system;

FIG. 19 shows a flow chart of a method for position detection; and

FIG. 20 shows a flow chart for operation of a position detection system.

### DETAILED DESCRIPTION

Low cost position encoders can be used in a variety of application in which position encoders were not previously used. For example, a low-cost means for relative position detection can be used with toys that interact with the real world. Such toys can include, for example, action figures with multiple parts. To facilitate interaction between the action figure and a computing device, an encoder detects the positions of the parts of the action figure and then conveys this information to a computing device. Another application might be a “building block” set whose component parts may convey their relative positions to a computing device for subsequent display to a user.

### Position-Sensitive Vibration Sources

A position-sensitive vibration source (PSVS) is a device configured on a joint, wherein the joint comprises two members which may move relative to each other. When the two elements of the joint move with respect to each other, the PSVS generates a vibration signal which may be detected with a vibration-detecting device (VDD). Joints may be rotary (with rotary motion between the two elements) or linear (with linear motion between the two elements). Other types of joints also fall within the scope of the invention. Some systems with a multiplicity of j oints may comprise only one or more rotary joints, one or more linear joints, or a mixture of various types of j oints.

Excitatory and Vibratory Elements, and Position-Sensitive Interactions Between them

In embodiments, a PSVS may comprise a vibratory element (typically attached to one member of the joint) and an excitatory element (typically attached to the other member of the joint). When the two parts of the joint move relative to each other, the excitatory element moves with respect to the vibratory element, inducing a position-sensitive interaction between the excitatory element and the vibratory element, causing the vibratory element to generate a vibration signal with a characteristic frequency spectrum, different from the characteristic frequency spectra of any of the other PSVSs in the system of joints.

In the following disclosure, vibratory elements comprising a reed are disclosed, wherein the characteristic frequency spectrum of the reed may be determined by the material from which the reed is made, as well as the dimensions and other aspects (such as heat-treating) of the reed material. Other types of vibratory elements also fall within the scope of the disclosure. Examples of other vibratory elements include various types of spring such as a leaf spring or coil spring, or a membrane, or a spring-loaded shape such as a rod or strip of material. Also in the following detailed description, the reed is characterized as being on a static mount and the multiplicity of teeth being attached to a moving member, however, within the scope of the disclosure are also embodiments in which the reed is attached to a moving member and the multiplicity of teeth is attached to a static mount.

The position-sensitive interaction between the excitatory element and the vibratory element may be physical contact (such as a tooth contacting and deflecting a reed), or a magnetic interaction (such as a magnetized gear which magnetically attracts a plunger to contact a vibratory element). Various excitatory elements and vibratory elements fall within the scope of the invention.

### Characteristic Frequency Spectra

In the disclosure below, the vibratory elements (for example, reeds) are characterized by their “center frequencies”. This is a special case of a characteristic frequency spectrum wherein the spectrum comprises only a single frequency. In general, most vibratory elements will vibrate at a number of frequencies simultaneously and this mixture of frequencies (each with a characteristic amplitude relative to the other frequencies) is described as the “characteristic frequency spectrum”. Various frequency spectra of vibratory elements (both with a single center frequency and with a mixture of frequencies) fall within the scope of the invention.

### Exemplary Embodiments of Excitatory and Vibratory Elements

For exemplary purposes, in the disclosure below, a multi-tooth gear is disclosed as an excitatory element, and a reed is disclosed as a vibratory element. However, as described above, a number of types of excitatory elements, vibratory elements, and position-sensitive interactions fall within the scope of the invention.

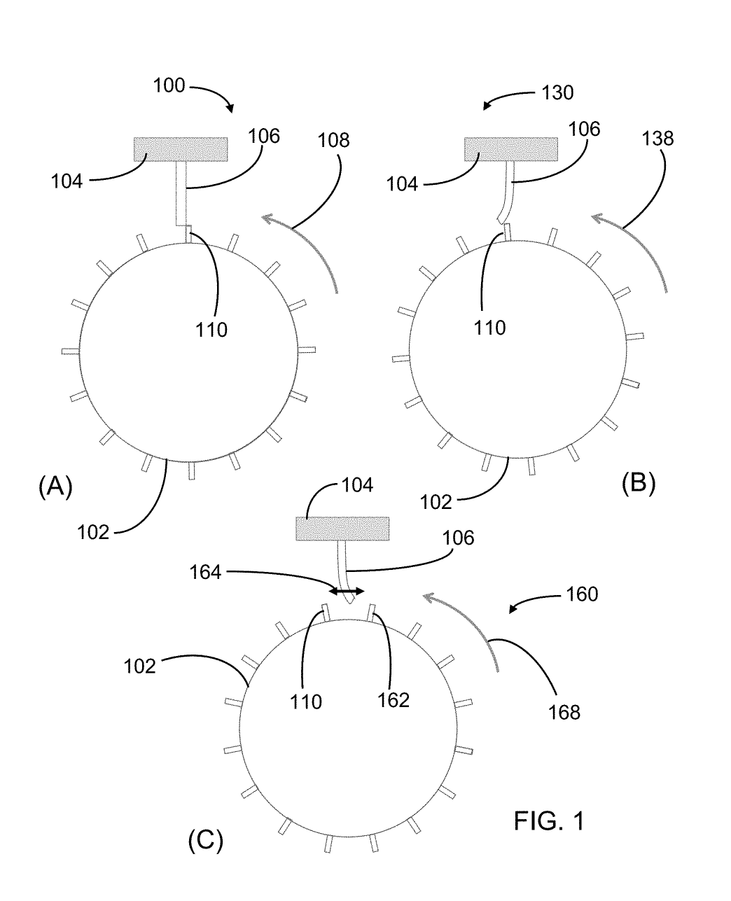

FIG. 1 shows three views of an embodiment, each view illustrating a different angular position around a rotary joint. In the following sections, a “reed” may refer to a thin strip of material configured to be vibratory, or another type of spring such as a leaf spring or coil spring, or a membrane, or a spring-loaded shape such as a rod or strip of material. Also in the following sections, the reed is characterized as being on a static mount and the multiplicity of teeth being attached to a moving member, however, within the scope of the disclosure are also embodiments in which the reed is attached to a moving member and the multiplicity of teeth is attached to a static mount. Within still other embodiments falling within the scope of the disclosure, both the reed and the multiplicity of teeth may be attached to members which may move relative to each other.

View (A) shows the rotary joint at a first angular position 100 where reed 106, supported by static mount 104 has just come into contact with tooth 110 as joint 102 rotates counter-clockwise 108. At position 100, vibration of reed 106 is prevented by the physical contact with tooth 110.

View (B) shows the rotary joint from view (A) after an additional rotation 138 counter-clockwise, wherein tooth 110 is exerting a force on reed 106, causing it to bend to the left as shown. Since reed 106 is still in contact with tooth 110, it cannot vibrate in view (B).

View (C) shows the rotary joint from view (B) after an additional rotation 168 counter-clockwise, wherein tooth 110 now has released reed 106, allowing it to vibrate 164. In embodiments, various reeds may be tuned to specific oscillation frequencies, determined by the physical characteristics of the reeds such as the choice of material, thickness, length, etc.

As the joint 102 in FIG. 1 continues to rotate counter-clockwise, past the position in view (C), reed 106 will continue to vibrate 164 but with a generally exponentially-decreasing amplitude as it dissipates the initial energy arising from the bending of reed 106 induced by contact with tooth 110 shown in view (B). Eventually, after joint 102 has rotated approximately an angle of 360°/N, where N is the number of teeth arrayed circumferentially around joint 102 (N=16 in FIG. 1), tooth 162 will come into contact with reed 162, thereby causing it to cease vibrating. At this point, view (A) will represent the configuration of the joint 102, but with tooth 162 contacting reed 106 instead of tooth 110. As the joint 102 continues to rotate, the joint configuration will continue to repeat through views (A) to (C), then back to (A) to (C), etc. Note that for the embodiment shown here, rotation of joint 102 may be counter-clockwise (CCW), or clock-wise (CW), or a combination of rotations in both directions. Both rotations CW and CCW will induce the same detectable vibrations of reed 106.

For the embodiment in FIG. 1 relative rotations of joint 102 may be detected to a precision of 360°/N. There are two aspects of the vibrational signal from the embodiment in FIG. 1 which may be important for some applications:
1) The vibrational signal does not indicate the absolute angular orientation of joint 102—only relative angular motion is indicated; and
2) The vibrational signal does not indicate which way (CW, CCW, or a combination of both CW and CCW) that joint 102 is rotating.

For situations where the absolute angular position is either unimportant or may be determined by other means, aspect #1 may be unimportant. Joints having a “home” sensor, for example, in some embodiments may enable the relative angular position to be converted to an absolute angular position.

For situations where the specific rotational direction (CW or CCW) of joint 102 is either already known or limited to a single direction (either only CW, or only CCW, but not both), aspect #2 may be unimportant.

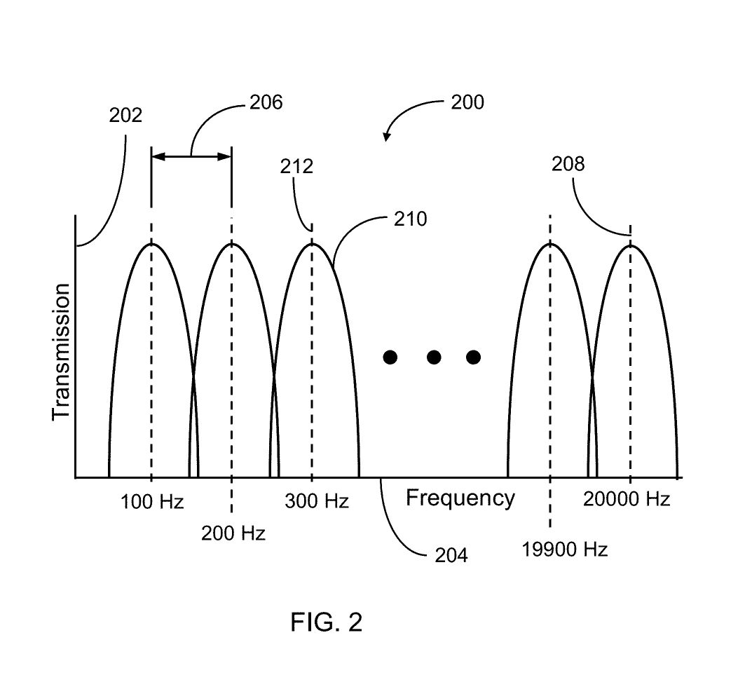

FIG. 2 shows a vibration frequency spectrum 200 with passbands 210 for multiple bandpass filters. Center frequencies 212 ranging from 100 Hz up to a maximum 208 at 20000 Hz, with separations 206 of 100 Hz, are shown for exemplary purposes only. The vertical axis 202 represents the transmission fraction (amount of input signal which is transferred through the signal detector filter) as a function of frequency 204 (typically sound or mechanical vibration), for each signal detector. Each signal detector may be characterized by its specific characteristic frequency spectrum, f, transmitting frequencies in a passband f±Δf, but highly attenuating frequencies outside of the passband.

Each signal detector may also comprise one or more of the following aspects:
1) A characteristic frequency spectrum, f, for a frequency filter.
2) A frequency filter passband half-width, Δf, such that the signal detector will detect only frequencies over an approximate range from f−Δf to f+Δf.
3) A high degree of attenuation of frequencies outside the passband in #2.
4) An automatic gain control (AGC) to compensate for differences in detected signal amplitudes (loudness or vibration magnitude). These differences may arise from one or more sources, including the physical vibration amplitude of the reed (such as reed 106 in FIG. 1, for example), the distance of the reed from the signal detector, sources of attenuation of the initial signal between the reed and the signal detector, etc.
5) An envelope detector, which generates a signal corresponding to the magnitude of the vibration signal.
6) An output signal generator, generating an output signal characterized by at least two levels, a first level indicating that a signal is being detected, and a second level indicating the absence of a signal.

A signal detector may be implemented on devices such as: a cellular phone, a tablet computer, a laptop computer, a desk-top computer, or a dedicated electronic device. Implementations may embody multiple signal detectors operating in parallel within a single device, such that the multiple signal detectors (each corresponding to a single passband, such as 210) may be within a cellular phone, etc. In some embodiments, the signal detector may comprise a Fast-Fourier Transform (FFT) calculation

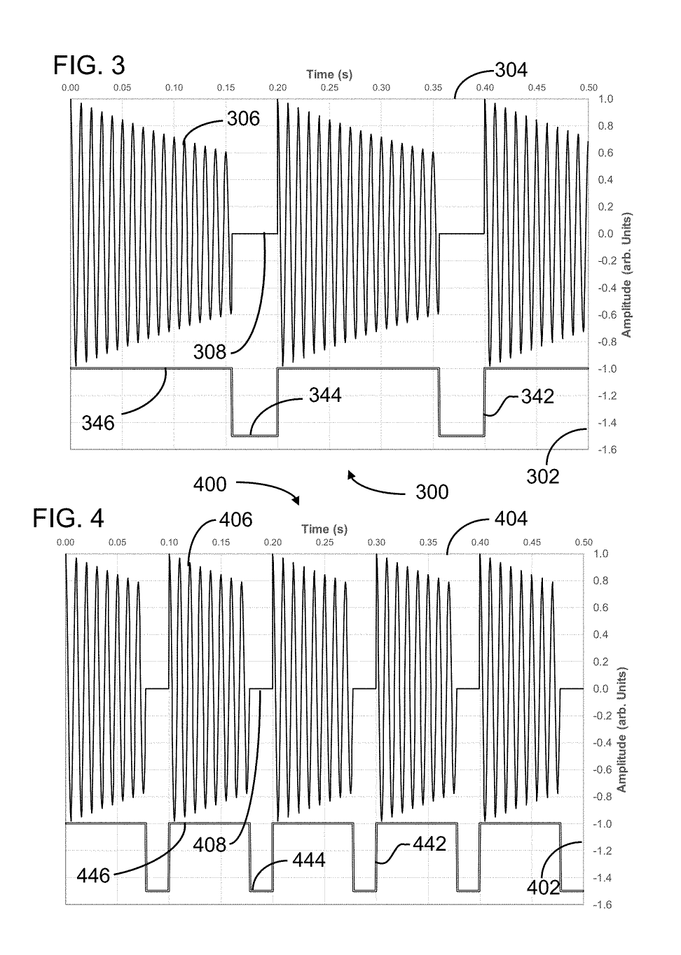

The embodiment in FIG. 1 may be used to generate the signals illustrated in FIGS. 3-8. Other embodiments may also be employed to produce the signals in FIGS. 3-8.

FIG. 3 shows 300 a vibration signal 306 and an output signal 342 from a first signal detector for a first degree of freedom in an embodiment moving at a constant first speed. The signal amplitude 302 (with an arbitrary vertical scale) is a function of time 304 (with an exemplary horizontal scale). In this example, the reed has an oscillation frequency of 100 Hz. The oscillating signal 306 decays with an exponential attenuation constant 0.30 s (the signal decays to 1/e in 0.03 s). For some embodiments, reed 106 may produce the decaying vibration signal 306 for view (C) in FIG. 1 where the reed is free to vibrate after being bent [view (B)] and then released [between views (B) and (C)]. Once joint 102 has rotated around to view (A), however, the vibration signal 306 will stop (changing to zero signal 308) due to contact between reed 106 and tooth 110—the configuration in FIG. 1 view (A) may correspond to the beginning of zero signal 308. Output signal 342 has level 344 during zero signal 308 and level 346 during vibration signal 306. In an example where there are N teeth, the time intervals (in this example, 0.2 s) between the starting of vibration signals 306 correspond to an increment of 360°/N in rotation of joint 102. In some embodiments, the leading edge of the output signal 342 (a rise from level 344 to level 346) could be detected as an indication that another rotational increment of 360°/N has occurred. In other embodiments, the trailing edge of the output signal (a drop from level 346 to level 344) could be detected as an indication that another rotational increment of 360°/N has occurred.

FIG. 4 shows 400 a vibration signal 406 and an output signal 442 from the first signal detector for the first degree of freedom for the embodiment in FIG. 3 moving at a constant second speed which is twice the first speed. The signal amplitude 402 (with an arbitrary vertical scale) is a function of time 404 (with an exemplary horizontal scale). Because the joint (for example joint 102 in FIG. 1 for a first embodiment) is rotating twice as fast, reed 106 travels between tooth 110 and tooth 162 in half the time as in FIG. 3. The vibration frequency (in this example 100 Hz) and the decay time (in this example 0.30 s) of the oscillation remain the same as in FIG. 3 since both the vibration frequency and the decay rate are independent of the excitation rate of oscillation resulting from contact between successive teeth (such as tooth 110) and reed 106. The signal amplitude 402 (with an arbitrary vertical scale) is a function of time 404 (with an exemplary horizontal scale). Output signal 442 has level 444 during zero signal 408 and level 446 during vibration signal 406.

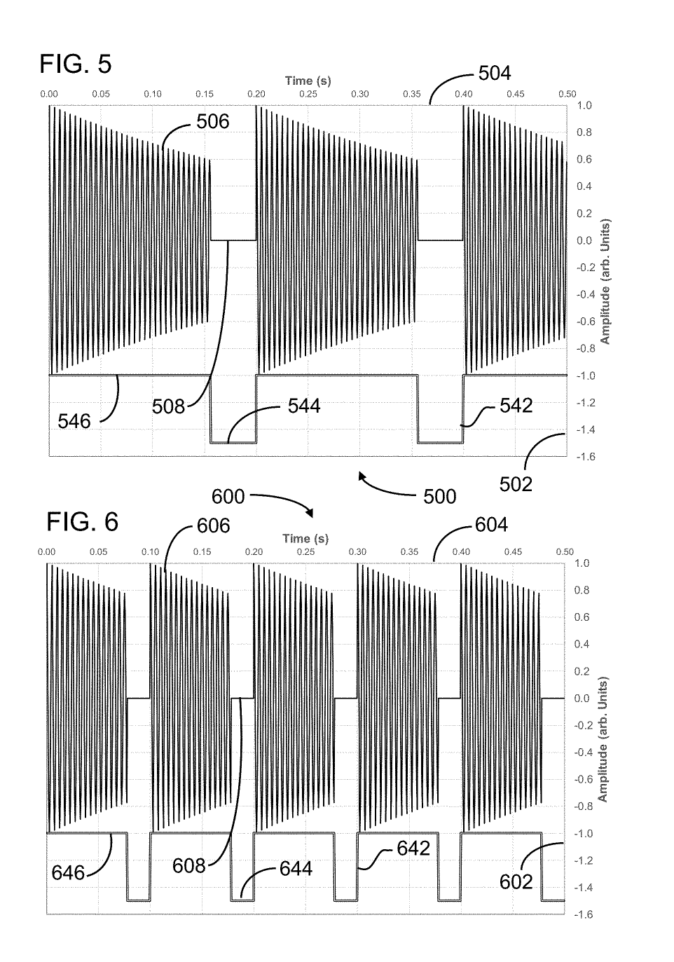

FIG. 5 shows 500 a vibration signal 506 and an output signal 542 from a second signal detector for a second degree of freedom in the embodiment of FIG. 3 moving at a constant first speed. The signal amplitude 502 (with an arbitrary vertical scale) is a function of time 504 (with an exemplary horizontal scale). In this example, the reed has an oscillation frequency of 200 Hz, twice the frequency of the reed in FIGS. 3-4. The vibration signal 506 decays with an exponential attenuation constant of 0.30 s. For some embodiments, reed 106 could produce the decaying vibration signal for view (C) in FIG. 1 where the reed is free to vibrate after being bent [view (B)] and then released [between views (B) and (C)]. Once joint 102 has rotated around to view (A), however, the vibration signal 506 will stop due to contact between reed 106 and tooth 110—the configuration in FIG. 1 view (A) may correspond to the beginning of zero signal 508. Output signal 542 has level 544 during zero signal 508 and level 546 during vibration signal 506. FIG. 5 may represent the motion of a second joint, with a second reed generating a vibration signal which is detected by a second signal detector.

FIG. 6 shows 600 a vibration signal 606 and an output signal 642 from the second signal detector for the second degree of freedom for the embodiment in FIG. 3 moving at a constant second speed which is twice the first speed. The signal amplitude 602 (with an arbitrary vertical scale) is a function of time 604 (with an exemplary horizontal scale). The vibration frequency (in this example 200 Hz) and the decay time (in this example 0.30 s) of the oscillation remain the same as in FIG. 5 since both the vibration frequency and the decay rate are independent of the excitation rate of vibration signals resulting from contact between teeth (such as tooth 110) and reed 106. Output signal 642 has level 644 during zero signal 608 and level 646 during vibration signal 606.

The signals in FIGS. 3-4 and in FIGS. 5-6 may be detected simultaneously using the separated bandpass ranges as illustrated, for example, in FIG. 2. Thus, the first signal detector could monitor the rotation of a first joint, while the second signal detector was monitoring the rotation of a second joint. The limits on the rotation speeds of the joints are determined by the vibration frequencies of the two reeds generating the signals in FIGS. 3-4 and in FIGS. 5-6. As long as each reed is able to vibrate a few cycles with the characteristic frequency spectrum of the bandpass range of a signal detector, this may be sufficient to separate the signal from other signals (detected by other signal detectors) produced by other reeds monitoring other joints. Thus, for the exemplary numbers shown in FIGS. 3-4, where the frequency f=100 Hz (0.01 s/cycle), in an example with N=16 teeth around 360°, for a rotation speed of 1 rps, there would be 16 excitations per second of the vibration signal, giving approximately 0.067 s to vibrate, which is sufficient for the reed producing the vibration signals in FIGS. 3-4 to make 6.7 cycles (at 0.01 s/cycle). A reed such producing the vibration signals in FIGS. 5-6 (200 Hz center frequency of a characteristic frequency spectrum) would undergo 13.3 cycles in 0.067 s.

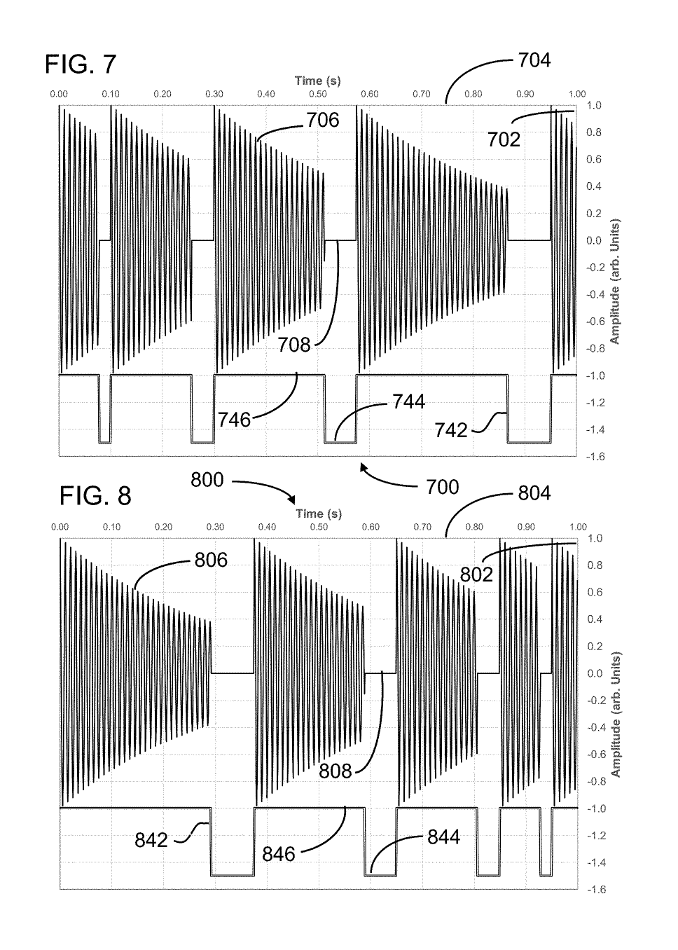

FIG. 7 shows 700 a vibration signal 706 and an output signal 742 from the second signal detector for the second degree of freedom in the embodiment of FIG. 3 moving at a decreasing rotational speed. The signal amplitude 702 (with an arbitrary vertical scale) is a function of time 704 (with an exemplary horizontal scale). The time separation between the first and second excitations of vibration at the left of FIG. 7 is 0.10 s. In an example where the joint has N=16 teeth evenly spaced around the circumference of the joint (as, for example, in FIG. 1), this corresponds to an average rotation rate, R1, of:

R1=(360°/16)/(0.1 s)=225°/s corresponding to 0.625 rps=37.5 rpm

As the rotation speed decreases, the spacing between the beginnings of vibration signals 706 increases, in this example to 0.2 s between the second and third vibration excitations. This corresponds to a reduced average rotation rate, R2, of:

R2=(360°/16)/(0.2 s)=112.5°/s corresponding to 0.375 rps=18.75 rpm

Subsequent time intervals between the beginnings of vibration signals 706 (each corresponding to a reed encountering a tooth as illustrated, for example, in FIG. 1) become progressively longer, so that between the fourth and fifth vibration signals 706 (with a time separation of 0.375 s), the average rotation rate, R4, is:

R4=(360°/16)/(0.375 s)=60°/s corresponding to 0.167 rps=10 rpm

Output signal 742 has level 744 during zero signal 708 and level 746 during vibration signal 706.

FIG. 8 shows a vibration signal 806 and an output signal 842 from the second signal detector for the second degree of freedom in the embodiment of FIG. 3 moving at an increasing speed. The signal amplitude 802 (with an arbitrary vertical scale) is a function of time 804 (with an exemplary horizontal scale). Output signal 842 has level 844 during zero signal 808 and level 846 during vibration signal 806. Since the rotation speed is increasing from left to right in the figure, the time intervals between excitations of vibration are progressively decreasing. The same calculations for average rotational speed apply here as in FIG. 7.

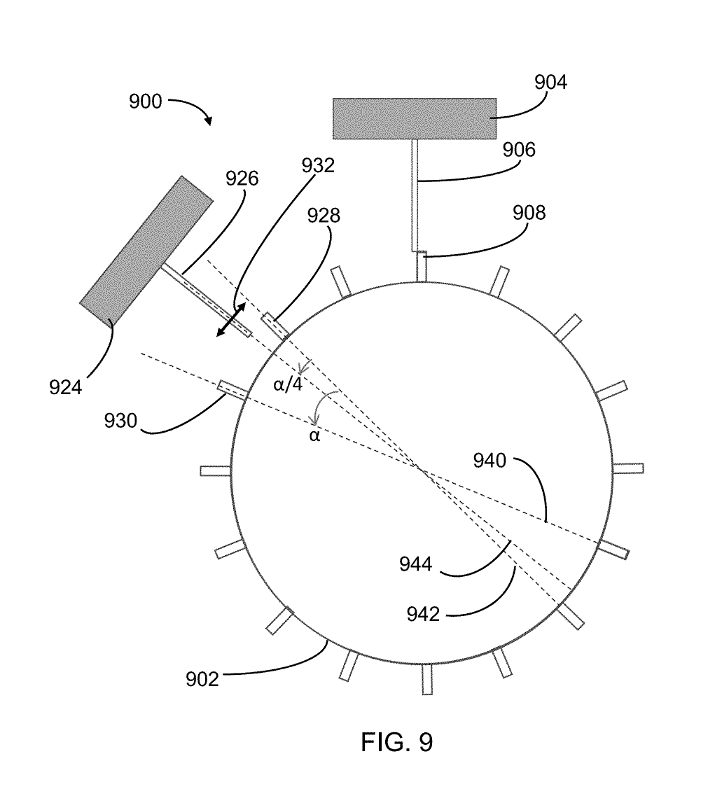

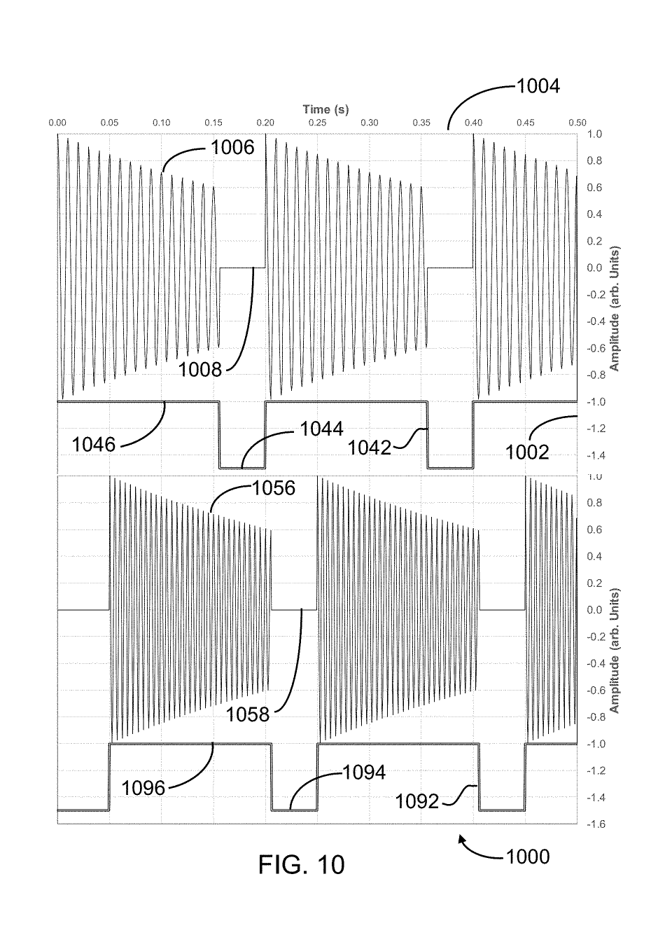

FIG. 9 shows a view 900 of an embodiment for a rotary joint. This embodiment comprises two reeds 906 and 926, supported by static mounts 904 and 924, respectively. In some embodiments, reeds 906 and 926 may be supported by a single static mount. This embodiment may address a need to determine whether joint 902 is rotating clockwise (CW) or counter-clockwise (CCW)—this was aspect #2 for the embodiment in FIG. 1. Reed 906 is shown in contact with tooth 908 [similar to view (A) in FIG. 1]. Reed 926 is between tooth 928 and tooth 930 [similar to view (C) in FIG. 1]—it is shown to be vibrating 932 as a result of previous contact with either tooth 928 or tooth 930 [as in view (B) of FIG. 1]. Reeds 906 and 926 encounter the same set of N teeth around the circumference of joint 902.

Line 940 extends through the center of tooth 930, while line 942 extends through the center of tooth 928—as joint 902 rotates, lines 940 and 942 rotate with it. The angle, a, between lines 940 and 942 (which remains constant as joint 902 rotates) is determined by the total number of teeth around joint 902:

α=360°/N=360°/16=22.5°

where N=number of teeth around joint 902, and where in the example in FIG. 9, N=16.

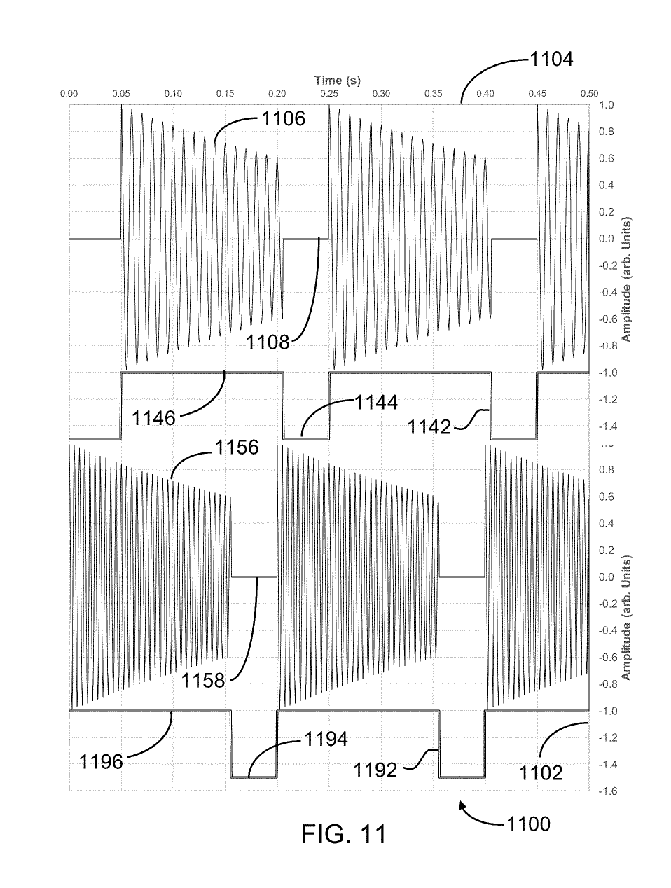

Line 944 extends through the center of reed 926, statically supported by mount 924 so that line 944 does not rotate with joint 902. The relative (static) positions of reeds 906 and 926 are set such that when joint 902 is rotated so that reed 906 is just contacting tooth 908, the angle between lines 942 and 944=α/4, as shown. FIGS. 10-11 illustrate a method for determining the rotational direction of joint 902 by using simultaneous vibration signals from reeds 906 and 926.

For the embodiment in FIG. 9, relative rotations of joint 902 may be detected to a precision of 360°/N. There is one aspect of the vibrational signals from the embodiment in FIG. 9 which may be important for some applications: the vibrational signals from reeds 906 and 926 do not indicate the absolute angular orientation of joint 902—only relative angular motion is indicated—this is the same as the first aspect for the embodiment in FIG. 1. A benefit of the dual-reed configuration in FIG. 9 is that this embodiment may enable the determination of the direction of rotation (CW or CCW), which was the second aspect for the embodiment in FIG. 1.

For situations where the absolute angular position is either unimportant or may be determined by other means, the above aspect may be unimportant. Joints having a “home” sensor, for example, in some embodiments may enable the relative angular position to be converted to an absolute angular position.

In some embodiments, FIGS. 10-11 may be generated by the embodiment in FIG. 9. Other embodiments may also be employed to generate the vibration signals in FIGS. 10-11. In this example, vibration signals 1006 and 1106 may be generated by reed 906, and vibration signals 1056 and 1156 may be generated by reed 926. In this example, reed 906 has a vibration frequency of 100 Hz, while reed 926 has a vibration frequency of 200 Hz and both reeds 906 and 926 have decay times of 0.30 s. Vibration signals 1006 and 1056 and output signals 1042 and 1092, may be from first and second signal detectors, respectively. Particular vibration frequencies and decay constants are for exemplary purposes only.

FIG. 10 shows 1000 the relative timing of vibration signals 1006 and 1056, and output signals 1042 and 1092, for a joint as illustrated in FIG. 9 moving in a counter-clockwise (CCW) direction. The signal amplitude 1002 (with an arbitrary vertical scale) is a function of time 1004 (with an exemplary horizontal scale). Examination of FIG. 9 shows that as joint 902 rotates CCW, reed 906 will contact tooth 908 slightly before reed 926 contacts tooth 928. For example, assume joint 902 has N=16 teeth around a circumference of 360° and is rotating at a steady rate of R=5/16 rps (rotations per second). Then reed 906 will encounter a tooth every time interval, ΔT1:

ΔT1=1/(NR)=1/[16(5/16)]=0.2 s.

Thus, successive beginnings of vibration signal 1006 are 0.2 s apart. Since reed 926 is being contacted by the same teeth around joint 902 as reed 906, successive beginnings of vibration signal 1056 are also spaced 0.2 s apart. The time difference between the beginnings of vibration signals 1006 and 1056 is determined by the relative angular displacement of reeds 906 and 926 as discussed in FIG. 9. The angular displacement α/4 between lines 942 and 944, compared with the angular displacement, a, between lines 940 and 942 causes vibration signal 1056 to be delayed by an amount ΔT2:

ΔT2=[(α/4)/α]ΔT1=0.05 s.

Output signal 1042 has level 1044 during zero signal 1008 and level 1046 during vibration signal 1006. Similarly, output signal 1092 has level 1094 during zero signal 1058 and level 1096 during vibration signal 1056. The rotational speed may be determined from output signal 1042, from output signal 1092, or from a combination of both output signals 1042 and 1092. The direction of rotation (in this example, CCW) may be determined by comparison of the relative timing of output signals 1042 and 1092—for example, the positive-going transitions from level 1044 to level 1046 may occur an interval ΔT2 before the positive-going transitions from level 1094 to level 1096.

FIG. 11 shows 1100 the relative timing of vibration signals 1106 and 1156 and output signals 1142 and 1192, for the embodiment in FIG. 10, moving in a clockwise (CW) direction. The signal amplitude 1102 (with an arbitrary vertical scale) is a function of time 1104 (with an exemplary horizontal scale). Examination of FIG. 9 shows that as joint 902 rotates CW, reed 906 will be contacted by tooth 908 slightly after reed 926 contacts tooth 928. All the same assumptions apply to FIG. 11 as for FIG. 10 but now the time difference between vibration signals 1106 and 1156 is −ΔT2=−0.05 s, as may be seen by comparison of vibration signals 1106 and 1156. Output signal 1142 has level 1144 during zero signal 1108 and level 1146 during vibration signal 1106. Similarly, output signal 1192 has level 1194 during zero signal 1158 and level 1196 during vibration signal 1156.

The rotational speed may be determined from output signal 1142, from output signal 1192, or from a combination of both output signals 1142 and 1192. The direction of rotation (in this example, CW) may be determined by comparison of the timing of output signals 1142 and 1192—for example, the positive-going transitions from 1144 to 1146 may occur an interval ΔT2 after the positive-going transitions from 1194 to 1196.

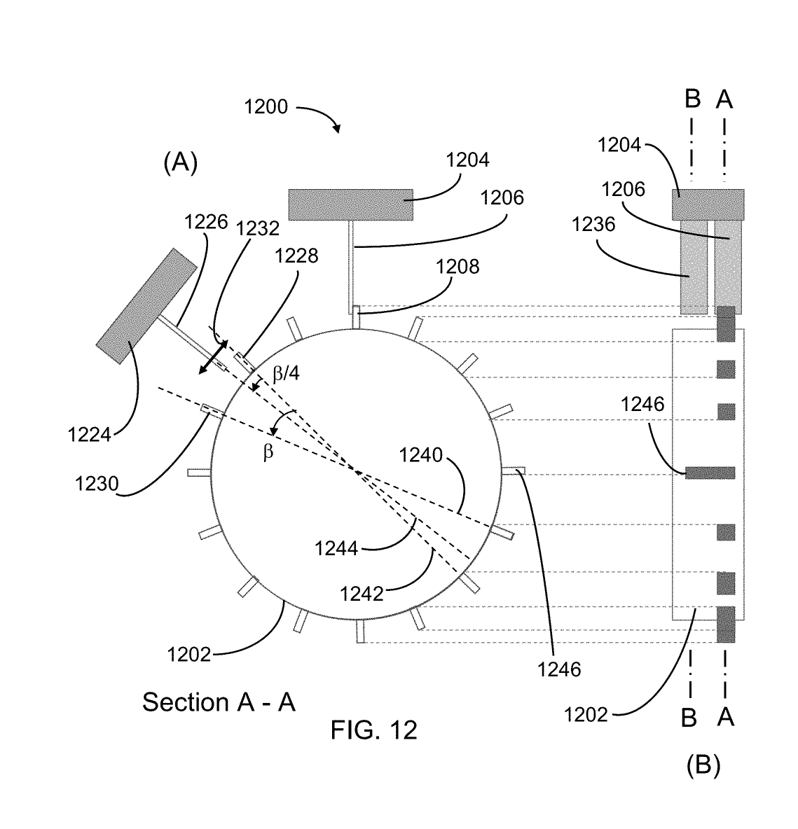

FIG. 12 shows two views 1200 of an embodiment for a rotary joint, comprising three reeds 1206, 1226, and 1236. View (A) is section A-A as indicated in view (B). Reeds 1206 and 1236 are both statically supported by mount 1204. Reed 1226 is statically supported by mount 1224. Other embodiments may comprise different static mounting arrangements for reeds 1206, 1226 and 1236. This embodiment may address the need to determine whether the joint 1202 is rotating clockwise (CW) or counter-clockwise (CCW)—this was aspect #2 for the embodiment in FIG. 1. This embodiment may also address the need for an absolute angular position measurement around joint 1202—this was aspect #1 for the embodiment in FIG. 1. Reed 1206 is shown in contact with tooth 1208 [similar to view (A) in FIG. 1]. Reed 1226 is between tooth 1228 and tooth 1230 [similar to view (C) in FIG. 1]—it is shown to be vibrating 1232 as a result of previous contact with either tooth 1228 or tooth 1230 [as in view (B) of FIG. 1]. Reeds 1206 and 1226 encounter the same set of N teeth around the circumference of joint 1202.

Line 1240 extends through the center of tooth 1230, while line 1242 extends through the center of tooth 1228—as joint 1202 rotates, lines 1240 and 1242 rotate with it. The angle, β, between lines 1240 and 1242 is determined by the total number of teeth around joint 902:

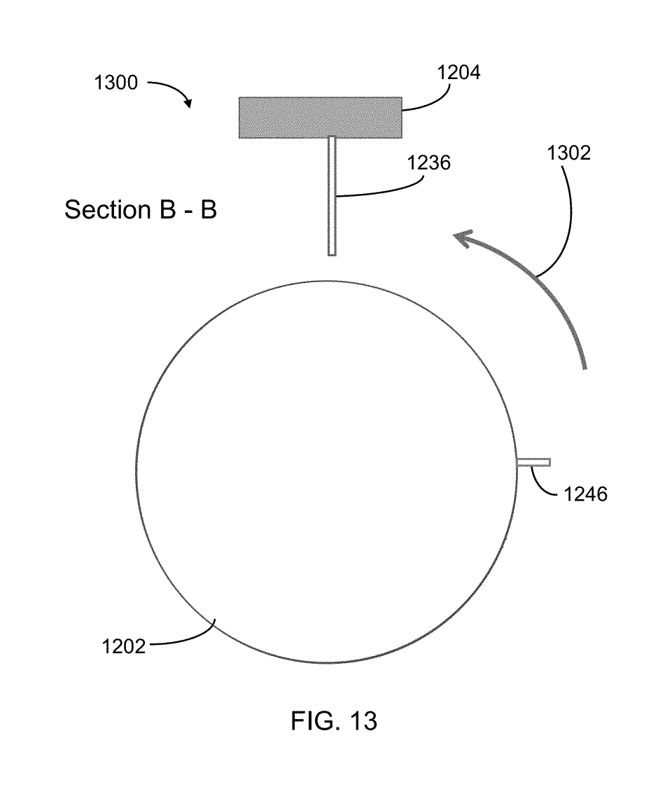

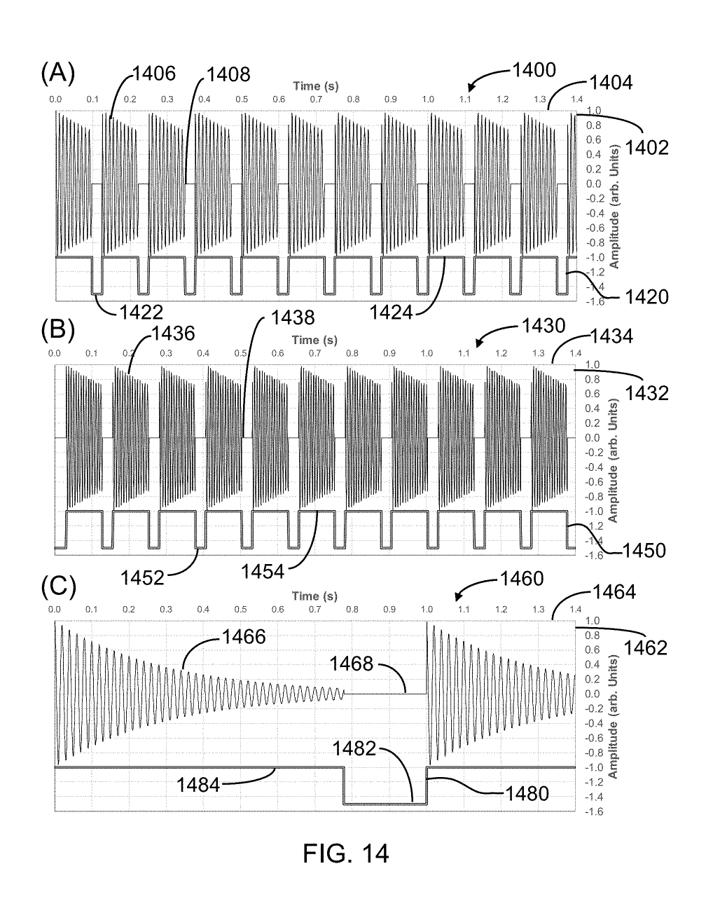

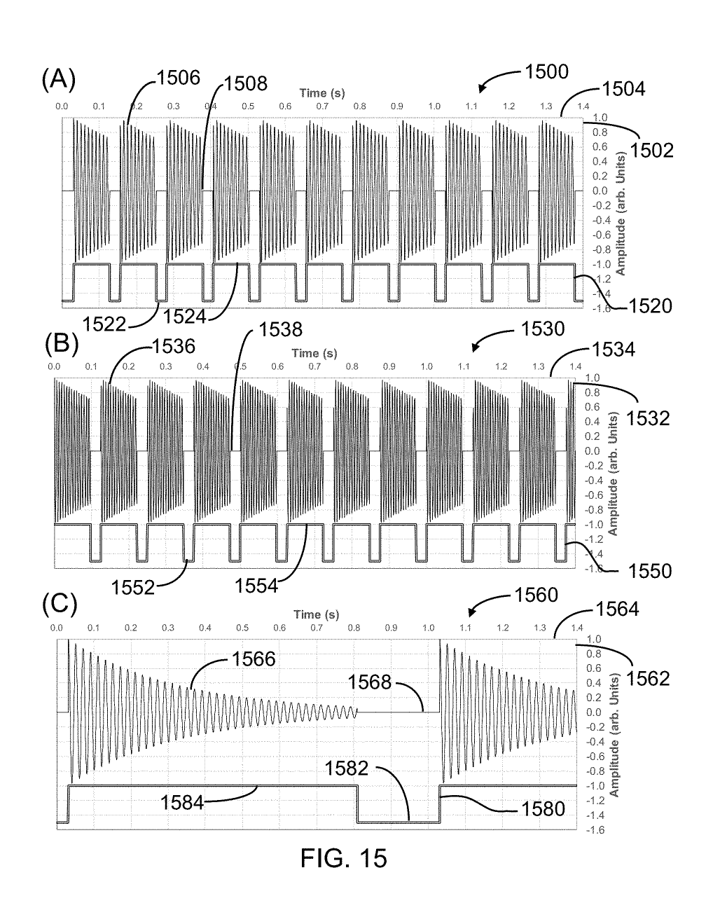

β=360°/N=360°/16=22.5°

where N=number of teeth around joint 1202, and in the example in FIG. 12, N=16. The variable β for FIGS. 12-13 serves a similar function as the variable α for FIG. 9. Line 1244 extends through the center of reed 9126, statically supported by mount 1224 so that line 1244 does not rotate with joint 1202. The relative (static) positions of reeds 1206 and 1226 are set such that when joint 1202 is rotated so that reed 1206 is just contacting tooth 1208, the angle between lines 1242 and 1244=β/4, as shown. FIGS. 14-15 illustrate a method for determining the rotational direction of joint 1202 by using simultaneous vibration signals from reeds 1206 and 1226. Other embodiments may also be employed to generate the vibration signals in FIGS. 14-15.

For the embodiment in FIG. 12, relative rotations of joint 1202 may be detected to a precision of 360°/N. The vibrational signals from reeds 1206 and 1226 do not indicate the absolute angular orientation of joint 902—only relative angular motion is indicated. A benefit of the dual-reed configuration in FIG. 12 is that this embodiment may enable the determination of the direction of rotation (CW or CCW), which was aspect #2 for the embodiment in FIG. 1. By adding a third reed 1236 as shown in FIG. 12 view (B) and in FIG. 13 (section B-B 1300), this embodiment may determine the absolute rotational angle of joint 1202, which was aspect #1 for the embodiment in FIG. 1. Reed 1236 functions as a “home” sensor as illustrated in FIG. 13. As joint 1202 rotates 1302, tooth 1246 will come into contact with reed 1236 only one time for each full 360° rotation, thereby functioning to indicated when joint 1202 has rotated to a position which places tooth 1246 vertical in section B-B in FIG. 13. FIGS. 14-15 illustrate this function in conjunction with the vibration signals from reeds 1206 and 1226.

In some embodiments, FIGS. 14-15 may be generated by the embodiment in FIGS. 12-13. Other embodiments may also produce FIGS. 14-15. Vibration signals 1406 and 1506 may be generated by reed 1206, vibration signals 1436 and 1536 may be generated by reed 1226, and vibration signals 1466 and 1566 may be generated by reed 1236. In this example, reed 1206 has a vibration frequency of 50 Hz, reed 1226 has a vibration frequency of 100 Hz, and reed 1236 has a vibration frequency of 150 Hz, reeds 1206, 1226, and 1236 all have decay times of 0.30 s. Vibration signal 1406 and output signal 1420 may be from a first signal detector. Vibration signal 1436 and output signal 1450 may be from a second signal detector. Vibration signal 1436 and output signal 1480 may be from a third signal detector. Particular vibration frequencies and decay constants are for exemplary purposes only.

FIG. 14 shows 1400 the relative timing of vibration signals 1406 and 1436, and output signals 1420 and 1450, for a joint as illustrated in FIG. 12 moving in a counter-clockwise (CCW) direction. The signal amplitude 1402 (with an arbitrary vertical scale) is a function of time 1404 (with an exemplary horizontal scale). Examination of FIG. 12 shows that as joint 1202 rotates CCW, reed 1206 will contact tooth 1208 slightly before reed 1226 contacts tooth 1228. For example, assume joint 1202 has N=16 teeth (as in FIG. 12) around a circumference of 360° and is rotating at a steady rate of R=10/16 rps (rotations per second). Then reed 1206 will encounter a tooth every time interval, ΔT1:

ΔT1=1/(NR)=1/[16(10/16)]=0.1 s.

Thus, successive beginnings of vibration signal 1406 are 0.1 s apart. Since reed 1226 is being contacted by the same teeth around joint 1202 as reed 1206, successive beginnings of vibration signal 1436 are also spaced 0.1 s apart. The time difference between the beginnings of vibration signals 1406 and 1436 is determined by the relative angular displacement of reeds 1206 and 1226 as discussed in FIG. 12. The angular displacement β/4 between lines 1242 and 1244, compared with the angular displacement, β, between lines 1240 and 1242 causes vibration signal 1436 to be delayed by an amount ΔT2:

ΔT2=[(β/4)/β]ΔT1=0.025 s.

Output signal 1420 has level 1422 during zero signal 1408 and level 1424 during vibration signal 1406. Similarly, output signal 1450 has level 1452 during zero signal 1438 and level 1454 during vibration signal 1436. The rotational speed may be determined from output signal 1420, from output signal 1450, or from a combination of both output signals 1420 and 1450. The direction of rotation (in this example, CCW) may be determined by comparison of the relative timing of output signals 1420 and 1450—for example, the positive-going transitions from level 1422 to level 1424 may occur an interval ΔT2 before the positive-going transitions from level 1452 to level 1454.

Determination of the absolute rotation angle may be enabled using the third reed 1236, generating vibration signal 1466 and output signal 1480. As shown in FIG. 12, tooth 1246 is wider than the other N−1 teeth (such as teeth 1228 and 1230) arrayed around the circumference of joint 1202. As joint 1202 rotates (either CW or CCW), reed 1236 will only be induced to vibrate one time per rotation, unlike reeds 1206 and 1226 which are excited N times per rotation. Thus, vibration signal 1466, may function as a “home” sensor, indicating a specific angular orientation of joint 1202—in FIG. 13, this orientation would place tooth 1246 rotated 1302 vertically upwards, in contact with reed 1236. Output signal 1480 has level 1482 during zero signal 1468 and level 1484 during vibration signal 1466.

FIG. 15 shows 1500 the relative timing of vibration signals 1506 and 1536 and output signals 1520 and 1550, for the embodiment in FIG. 14, moving in a clockwise (CW) direction. The signal amplitude 1102 (with an arbitrary vertical scale) is a function of time 1104 (with an exemplary horizontal scale). Examination of FIG. 9 shows that as joint 902 rotates CW, reed 906 will be contacted by tooth 908 slightly after reed 926 contacts tooth 928. All the same assumptions apply to FIG. 11 as for FIG. 10 but now the time difference between vibration signals 1106 and 1156 is −ΔT2=−0.05 s, as may be seen by comparison of vibration signals 1106 and 1156. Output signal 11 has level 1144 during zero signal 1108 and level 1146 during vibration signal 1106. Similarly, output signal 1192 has level 1194 during zero signal 1158 and level 1196 during vibration signal 1156.

As for FIG. 14, the rotational speed may be determined from output signal 1520, from output signal 1550, or from a combination of both output signals 1520 and 1550. The direction of rotation (in this example, CW) may be determined by comparison of the relative timing of output signals 1520 and 1550—for example, the positive-going transitions from level 1522 to level 1524 may occur an interval ΔT2 after the positive-going transitions from level 1552 to level 1554. Output signal 1580 has level 1582 during zero signal 1568 and level 1584 during vibration signal 1566.

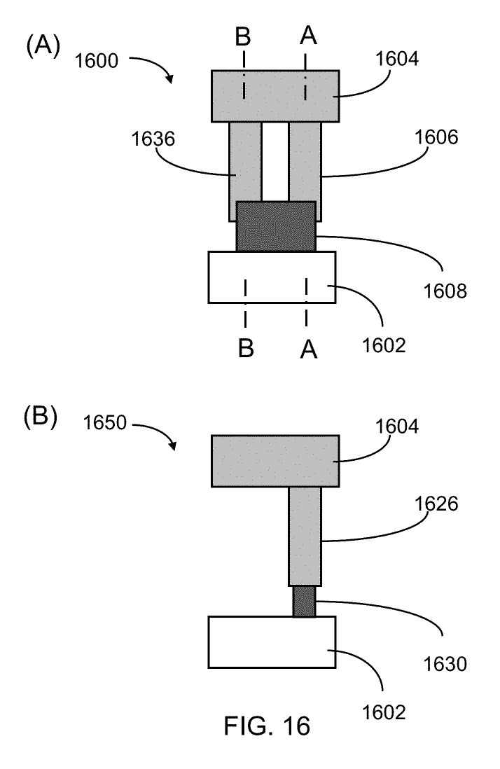

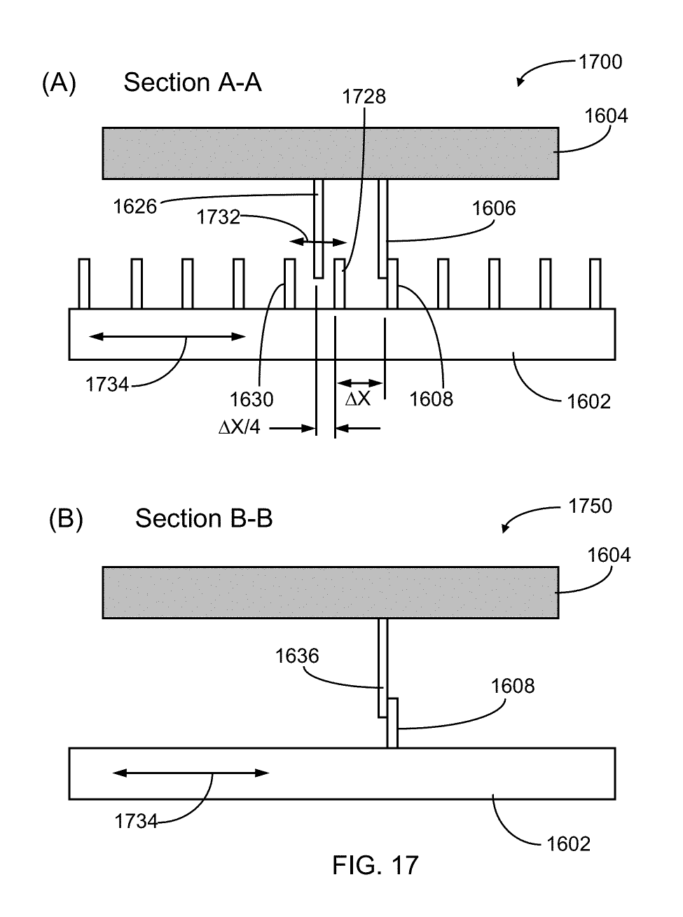

FIGS. 16-17 show an embodiment 1600 for a linear joint. IN FIG. 16, two cross-sections A-A and B-B are indicated. FIG. 17 view (A) illustrates cross-section A-A 1700, and FIG. 17 view (B) shows cross-section B-B 1750. This embodiment comprises three reeds 1606, 1626, and 1636, statically supported by mount 1604, and a linear array of equally-spaced teeth (such as tooth 1608). Other embodiments may comprise different static mounting arrangements for reeds 1606, 1626 and 1636. This embodiment functions similarly to the embodiment in FIGS. 12-13, but for a linear joint instead of a rotary joint. For this embodiment, linear motion 1734 is along an X-axis (left-to-right in FIG. 17) and by employing the three reeds, the direction of motion (+X-direction or −X-direction) may be determined, as well as the absolute X-position of the linear joint. In a comparison with the rotary joint embodiment in FIGS. 12-13, the following terminology substitutions may be made:

| ROTARY JOINT (e.g., FIGS. 12-13) | LINEAR JOINT (e.g., FIGS. 16-17) |
|---|---|
| CW motion | motion in +X-direction (to the right) |
| CCW motion | motion in −X-direction (to the left) |
| Angle between teeth = β | X-distance between teeth = ΔX |

With these substitutions, the operation of the linear joint embodiment in FIGS. 16-17 may be understood in view of the discussion of the rotary joint embodiment in FIGS. 12-13.

Reed 1626 is between tooth 1728 and tooth 1630 [similar to view (C) in FIG. 1]—it is shown to be vibrating 1732 as a result of previous contact with either tooth 1628 or tooth 1630 [as in view (B) of FIG. 1]. Reeds 1606 and 1626 encounter the same set of teeth along the length of linear joint as may be seen in FIG. 17 view (A).

FIGS. 14-15 illustrate a method for determining the direction of linear X-axis linear motion of joint 1602 by using simultaneous vibration signals from reeds 1606 and 1626. Other embodiments of linear joints may also be employed to generate the vibration signals in FIGS. 14-15. The vibrational signals from reeds 1606 and 1626 do not indicate the absolute X-position of joint 102—only relative angular motion is indicated. A benefit of the dual-reed configuration in FIGS. 16-17 is that this embodiment may enable the determination of the direction of linear motion (+X-direction or −X-direction). By adding a third reed 1636 as shown in FIG. 16 and FIG. 17 view (B), this embodiment may determine the absolute X-position of linear joint 1602. Reed 1636 functions as a “home” sensor as illustrated in FIG. 17 view (B). As joint 1602 moves along the X-axis 1734, tooth 1646 will come into contact with reed 1636 only one time for the entire range of X-axis motion of joint 1602, thereby functioning to indicated when joint 1202 has rotated to a position which places tooth 1246 vertical in section B-B in FIG. 13. FIGS. 14-15 illustrate this function in conjunction with the vibration signals from reeds 1206 and 1226. In some embodiments, FIGS. 14-15 may be generated by the embodiment in FIGS. 16-17. Other embodiments of linear joints may also produce FIGS. 14-15. Vibration signals 1406 and 1506 may be generated by reed 1606, vibration signals 1436 and 1536 may be generated by reed 1626, and vibration signals 1466 and 1566 may be generated by reed 1636.

FIG. 14 shows 1400 the relative timing of vibration signals 1406 and 1436, and output signals 1420 and 1450, for a linear joint moving in a −X-direction. Examination of FIG. 17 view (A) shows that as joint 1602 moves to the left (−X-direction), reed 1606 will contact tooth 1608 slightly before reed 1626 contacts tooth 1728. For example, assume joint 1602 has teeth spaced a distance ΔX=1 mm [as in FIG. 17 view (A)] and is rotating at a steady speed of V=10 mm/s. Then reed 1606 will encounter a tooth every time interval, ΔT1:

ΔT1=ΔX/V=(1 mm)/(10 mm/s)=0.1 s.

Thus, successive beginnings of vibration signal 1406 are 0.1 s apart. Since reed 1626 is being contacted by the same teeth around joint 1602 as reed 1606, successive beginnings of vibration signal 1436 are also spaced 0.1 s apart. The time difference between the beginnings of vibration signals 1406 and 1436 is determined by the relative linear displacement of reeds 1606 and 1626. For linear motion in the −X-direction, vibration signal 1436 will be delayed by an amount ΔT2:

ΔT2=[(ΔX/4)/ΔX]ΔT1=0.025 s.

The linear speed may be determined from output signal 1420, from output signal 1450, or from a combination of both output signals 1420 and 1450. The direction of linear motion may be determined by comparison of the relative timing of output signals 1420 and 1450—for example, the positive-going transitions from level 1422 to level 1424 may occur an interval ΔT2 before the positive-going transitions from level 1452 to level 1454.

Determination of the absolute X-position may be enabled using the third reed 1636, generating vibration signal 1466 and output signal 1480. As shown in FIG. 16 view (A), tooth 1208 is wider than the other teeth (such as teeth 1728 and 1630). As joint 1602 moves along the X-axis, reed 1636 will only be induced to vibrate at one location of joint 1602. Thus, vibration signal 1466, may function as a “home” sensor, indicating a specific X-position of joint 1602.

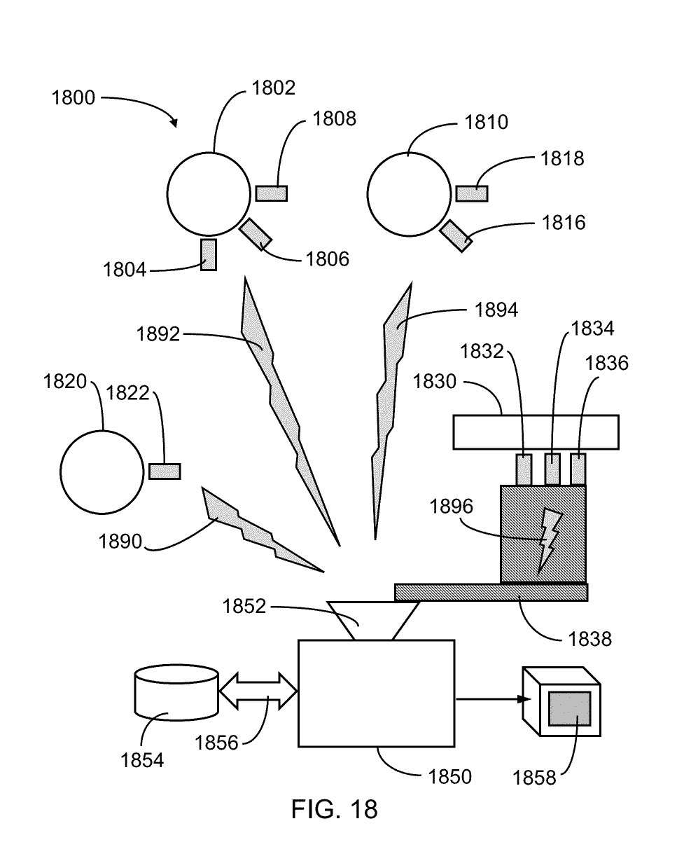

FIG. 18 shows a diagram of a position detection system 1800. The positions of a multiplicity of both rotary and linear joints may be simultaneously monitored in this embodiment. Three rotary joints 1802, 1810 and 1820 are shown, as well as a linear joint 1830.

Rotary joint 1802 has three reeds 1804, 1806, and 1808, and may be similar in structure to the embodiment in FIGS. 12-13. When rotary joint 1802 is rotating CCW, the vibration signals from reeds 1804, 1806 and 1808 in some embodiments may be similar to vibration signals 1406, 1436, and 1466. When rotary joint 1802 is rotating CW, the vibration signals from reeds 1804, 1806 and 1808 in some embodiments may be similar to vibration signals 1506, 1536, and 1566.

Rotary joint 1810 has two reeds 1816 and 1818, and may be similar in structure to the embodiment in FIG. 9. When rotary joint 1810 is rotating CCW, the vibration signals from reeds 1816 and 1818 in some embodiments may be similar to vibration signals 1006 and 1056. When rotary joint 1802 is rotating CW, the vibration signals from reeds 1816 and 1818 in some embodiments may be similar to vibration signals 1106 and 1166.

Rotary joint 1820 has a single reed 1822, and may be similar in structure to the embodiment in FIG. 1. When rotary joint 1820 is rotating, the vibration signals from reed 1822 in some embodiments may be similar to vibration signals 306, 406, 506, or 606.

Linear joint 1830 has three reeds 1832, 1834, and 1836 and may be similar in structure to the embodiment in FIGS. 16-17. When linear joint 1830 is moving in a −X-direction, the vibration signals from reeds 1832, 1834 and 1836 in some embodiments may be similar to vibration signals 1406, 1436, and 1466. When linear joint 1830 is moving in a +X-direction, the vibration signals from reeds 1832, 1834 and 1836 in some embodiments may be similar to vibration signals 1506, 1536, and 1566.

The vibration signals from rotary joints 1802, 1810, and 1820 may be transmitted to a sound receiving computing device 1850 by sound waves 1892, 1894, and 1890, respectively, which may be detected by microphone 1852. The vibration signals from linear joint 1830 may be transmitted to the sound receiving computing device 1850 by conduction 1896 through solid support 1838 directly to microphone 1852. Sound receiving computing device 1850 is connected through a network (wired or wireless), or by a direct connection (wired or wireless) 1856 to a non-volatile storage medium 1854. Sound receiving computing device 1850 may display the real-time results of the monitoring of the positions of joints 1802, 1810, 1820, and 1830 on display device 1858. For example, if sound receiving computing device 1850 is a smart phone, tablet computer, laptop computer, or desktop computer, in some embodiments non-volatile storage medium 1854 may comprise a hard-drive or solid-state storage device, and display device 1858 may comprise a display screen integrated with the sound receiving computing device 1850 and/or a separate (external) display monitor.

In order to simultaneously detect and separate the various vibration signals from the reeds in the four joints, it may be necessary for the center frequencies of each reed to be different, as illustrated in FIG. 2. In an embodiment, the following center frequencies may be characteristic of the reeds in the four joints being monitored simultaneously by the sound receiving computing device 1850 (all frequencies and decay constants are for exemplary purposes only):

| | Center Frequency | Decay Constant |
|---|---|---|
| | (Hz) | (s) |
| Rotary Joint 1802 | | |
| Reed 1804 | 100 | 0.30 |
| Reed 1806 | 200 | 0.30 |
| Reed 1808 | 300 | 0.30 |
| Rotary Joint 1810 | | |
| Reed 1816 | 400 | 0.30 |
| Reed 1818 | 500 | 0.30 |
| Rotary Joint 1820 | | |
| Reed 1822 | 600 | 0.30 |
| Linear Joint 1802 | | |
| Reed 1832 | 700 | 0.30 |
| Reed 1834 | 800 | 0.30 |
| Reed 1836 | 900 | 0.30 |

Sound receiving computing device 1850 may execute transforms, algorithms, or other processing routines stored in non-volatile memory 1854 and transferred to sound receiving computing device 1850 through link 1856. Results of the operation of sound receiving computing device on the vibration signals may be displayed on display device 1858.

In some embodiments, multiple joints 1802, 1810, 1820, and 1830 may be components of separate structures. In other embodiments, multiple joints 1802, 1810, 1820, and 1830 may be incorporated in a single structure, such as a children's action figure where the joints may comprise arm, leg and head joints, for example. In other embodiments, the multiple joints may comprise various components of a toy car, truck, airplane, robot, etc. In some embodiments, the display of joint positions on display device 1838 may be a display of the physical structure, such as the action figure, toy vehicle, robot, etc. In other embodiments, the display of joint positions on display device 1838 may be a numerical display of angles or coordinates of the moving members of j oints relative to the static members of the joints. In other embodiments, the joints may be rotary or on/off switches.

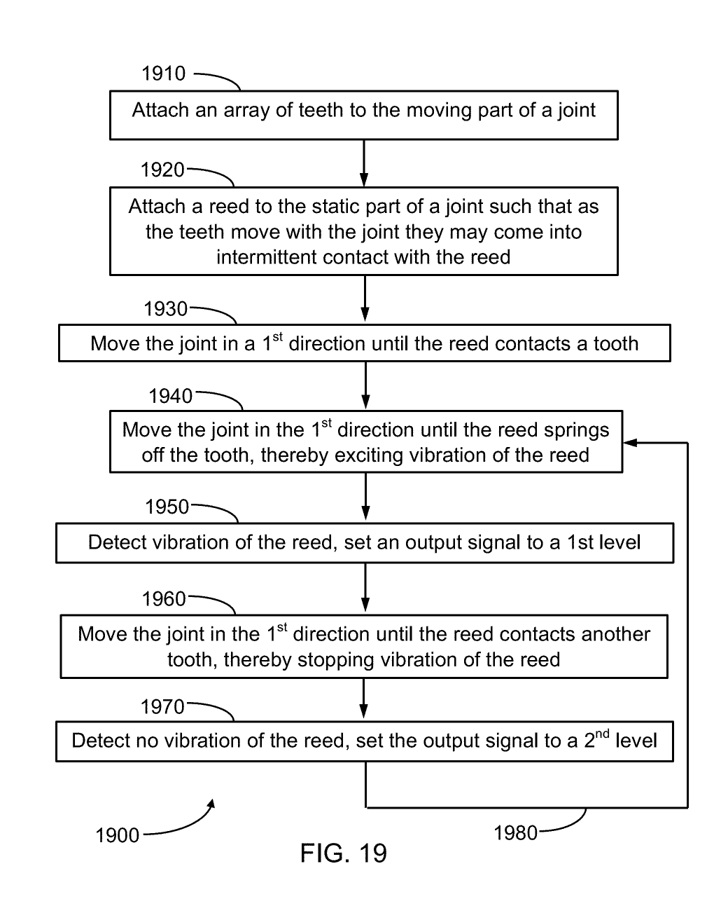

FIG. 19 shows a flow chart 1900 of a method for position detection for a joint. The steps of this embodiment may be performed by various embodiments such as those in FIG. 1, FIG. 9, FIGS. 12-13, FIGS. 16-17, or other embodiments also falling within the scope of the disclosure.

In Block 1910, a joint (either rotary, linear, or another motion configuration) is configured with a multiplicity of teeth which are attached to a moving part of the joint.

In block 1920, a reed may be attached to a moving part of the joint. The location of the reed may be set to contact (one at a time) a tooth in the multiplicity of teeth during motion of the joint. Examples are provided in FIG. 1, FIG. 9, FIGS. 12-13, and FIGS. 16-17, however other configurations fall within the scope of the disclosure. In some embodiments, a multiplicity of reeds may be configured to contact the same array of teeth on the moving part of the joint (as, for example in FIGS. 9, 12, and 16-17. In some embodiments, there may be an additional set of teeth attached to the moving part of the joint to facilitate additional functions, such as a “home” sensor as in FIGS. 12-13 and 16-17.

In block 1930, the joint is moved in a 1st direction until the reed comes into contact with a tooth in the multiplicity of teeth. If the reed was already vibrating due to an earlier contact with a tooth at this point it will stop vibrating—if the read was not vibrating already, it will continue to not vibrate.

In block 1940, the joint continues to turn in the 1st direction, causing the reed to bend [see FIG. 1 view (B), for example]. With small degrees of motion in the 1st direction, the reed will remain in contact with the tooth as it bends, and thus will not vibrate. As the joint moves farther in the 1st direction, eventually the reed will spring off the tooth [see FIG. 1 view (C), for example] and begin vibrating with a characteristic frequency spectrum determined by the design of the reed [choice of material, thickness and length of the reed, etc.].

In block 1950, the sound receiving computing device 1850 detects the vibration signal from the reed as described in FIG. 18. After performing various signal processing functions such as frequency separation (see FIG. 2), amplification and gain control, fast Fourier transforms, etc., sound receiving computing device 1850 may indicate that a vibration signal has been detected. Examples of a signal detection process have been provided for various embodiments, however other embodiments also fall within the scope of block 1950 and the disclosure. For the embodiment in FIG. 1, exemplary output signal levels 346, 446, 546, 646, 746, and 846 may indicate the presence of vibration signals. For the embodiment in FIG. 9, exemplary output signal levels 1046, 1096, 1146, and 1196 may indicate the presence of vibration signals. For the two embodiments in FIGS. 12-13 and 16-17, exemplary output signals 1424, 1454, 1484, 1524, 1554, and 1584 may indicate the presence of vibration signals.

In block 1960, the joint continues to move in the 1st direction until the reed contacts another tooth (next to the tooth that the reed contacted in block 1930). Contact between the reed and the tooth quickly damps any vibration of the reed.

In block 1970, the same signal detection process as in block 1950 may operate, however now an absence of a vibration signal is detected (instead of the presence of a vibration signal in block 1950). For the embodiment in FIG. 1, exemplary output signal levels 344, 444, 544, 644, 744, and 846 may indicate the absence of vibration signals. For the embodiment in FIG. 9, exemplary output signal levels 1044, 1094, 1144, and 1194 may indicate the absence of vibration signals. For the two embodiments in FIGS. 12-13 and 16-17, exemplary output signals 1422, 1452, 1482, 1522, 1552, and 1582 may indicate the absence of vibration signals.

Exiting from block 1970, link 1980 returns to block 1940 to continue the position detection method as the joint continues to move in a 1st direction. The speed of the joint moving in the 1st direction may change during method 1900. When motion of the joint in the 1st direction stops in either block 1940 or 1960, then method 1900 still stop until motion in the 1st direction starts again. Motion in a 2nd direction, which may be opposite from the 1st direction, starts, then method 1900 may be employed also.

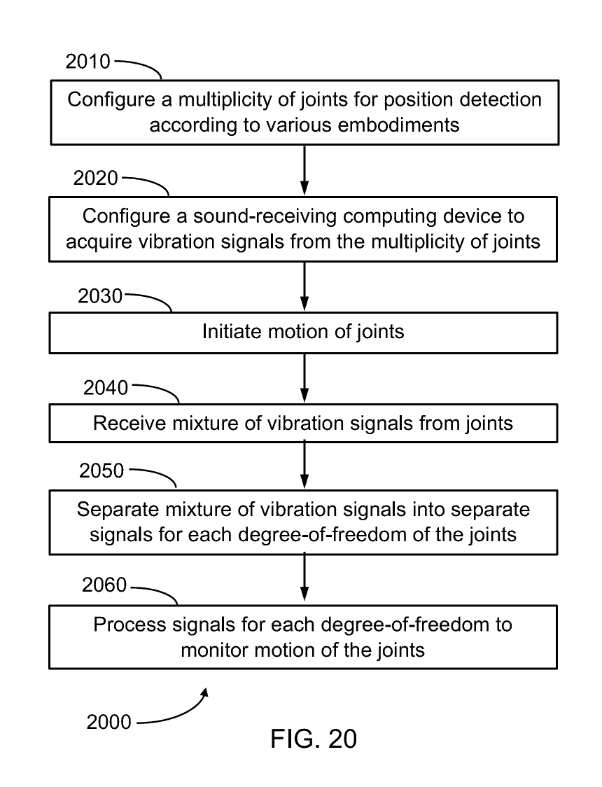

FIG. 20 shows a flow chart 2000 for an operating method of a position detection system. An example of a position detection system is illustrated in FIG. 18; however other embodiments may also perform the operating method in FIG. 20.

In block 2010, a multiplicity of joints (which may be rotary joints, linear joints, or other types of joints having a fixed portion and a moving portion) may be configured for position detection according to embodiments. Exemplary embodiments are illustrated in FIGS. 1, 9, 12-13, and 16-17, however other embodiments of joints fall within the scope of the disclosure. Blocks 1910 and 1920 in FIG. 19 provide one example of how a joint may be configured according to embodiments for position detection. Other methods for position detection also fall within the scope of block 2010 and the disclosure.

In block 2020, a sound receiving computing device is configured to detect vibration signals from the multiplicity of joints. One example of such a sound receiving computing device is illustrated in FIG. 18, however other embodiments also fall within the scope of block 2020 and the disclosure.

In block 2030, motion of one or more joints within the multiplicity of joints begins. As the joints move, the position detection teeth and reeds on each degree of freedom will periodically generate vibration signals.

In block 2040, as the joints move, the position detection teeth and reeds on each degree of freedom will periodically generate vibration signals. All the vibration signals will be mixed together as these signals travel outwards from each reed. As described in FIG. 18, these vibration signals will be received by the sound receiving computing device, such as 1850 in FIG. 18, and detected, such as by a speaker 1852 in FIG. 18.

In block 2050, the mixture of vibration signals from all the position detectors is separated into individual narrow frequency ranges, each corresponding to a particular reed on a specific degree-of-freedom of a joint, as shown in FIG. 2, for example. Various methods may be applied to this separation process, including Fast Fourier Transforms (FFTs), filter networks, digital signal processing, etc.

In block 2060, the separated signals are processed to determine the positions and directions of motion of various joints. The results from the processing may be displayed for a user on the display device 858.

For some embodiments, the initial sound energy generated by the vibrating reed may be amplified to increase the sound level reaching the microphone 1852 of the sound receiving computing device 1850. Various methods for performing sound amplification are known such as sound boxes and/or electronic amplifiers. In some embodiments, the amplification process may modify the characteristic frequency spectra of one or more of the PSVSs.

The following sections discuss vibration signal processing aspects for embodiments. A system for position detection may include:
1) One or more JOINTs, each comprising two mechanical members capable of moving one relative to the other, either linearly or rotationally. One of the members to be referred to as STATIC MEMBER and the other as MOVING MEMBER or ROTATING MEMBER.
2) For each JOINT, means for generating a sound or a sequence of sounds with substantially known attributes in response to incremental changes of known magnitude in the position of MOVING MEMBER with respect to STATIC MEMBER. The sound or sequence of sounds differing for different directions of motion. The sound or sequence of sounds to be referred to as PSC (Positive Step Code) for POSITIVE DIRECTION motion (POSITIVE being pre-defined for each JOINT) and NSC (Negative Step Code) for NEGATIVE DIRECTION motion (NEGATIVE also pre-defined for each JOINT). The known distance or angle, to be referred to as STEP_SIZE_P for POSITIVE DIRECTION motion and STEP_SIZE_N for NEGATIVE DIRECTION motion. Both PSC and NSC being unique to the JOINT.
3) For each JOINT, means for generating a sound or sequence of sounds with substantially known attributes, the generation done in response to MOVING MEMBER crossing one or more predefined positions or angles relative to STATIC MEMBER. The predefined positions or angles to be referred to as INDEX_POS(K), where K is an index in the range of 1 and Q, Q being the number of the positions or angles. The sound or sequence of sounds to be referred to as IC(K) (Index Code of K). Each of the IC(K) being unique.
4) A computing device with an associated sound receiver, to be referred to as VDD (vibration-detecting computing device), including:
   a. A processing unit and associated electronics capable of executing code
   b. A built-in or externally-connected sound receiver
   c. Means for code executing on the processing unit to access sound received from the sound receiver.
5) Code executing on VDD that approximates, for a JOINT L, the accumulated travel of MOVING MEMBER relative to STATIC MEMBER that has taken place from a time T0, including
   a. Means for resetting two variables, P and N, to 0, at time T0.
   b. Means for detecting PSC, NSC and IC patterns of the JOINT L in received sound.
   c. Means for incrementing P by STEP_SIZE_P upon detection of a PSC pattern of JOINT L in the received sound, where STEP_SIZE_P is the step size for JOINT L in the POSITIVE DIRECTION,
   d. Means for incrementing N by STEP_SIZE_N upon detection of a NSC pattern of JOINT L in the received sound, where STEP_SIZE_N is the step size for JOINT L in the NEGATIVE DIRECTION,
   e. Means for calculating the value Z=P−N, where Z approximates the accumulated travel for JOINT L that has taken place since T0.
6) Means for code executing on VDD to approximate, for a JOINT L, the absolute position of MOVING MEMBER relative to STATIC MEMBER including:
   a. Means for detecting PSC, NSC and IC patterns of the JOINT L on received sound.
   b. Means for resetting two variables P and N to 0 in response to detection of an IC pattern K of JOINT L
   c. Means for incrementing P by STEP_SIZE_P upon detection of a PSC pattern of JOINT L in the received sound, where STEP_SIZE_P is the step size for JOINT L in the POSITIVE DIRECTION,
   d. Means for incrementing N by STEP_SIZE_N upon detection of a NSC pattern of JOINT L in the received sound, where STEP_SIZE_N is the step size for JOINT L in the NEGATIVE DIRECTION,
   e. Means for calculating ABS=P−N+INDEX_POS(K), where ABS is the approximation of the absolute position of JOINT L.

In embodiments, means for generating PSC and NSC may include:
1) A plurality of mechanical contacting portions associated with MOVING MEMBER having equal and known distance between consecutive contacting portions. The distance to be referred to as DX. For a rotary Joint, the angle between the center of rotation of ROTATING MEMBER and any two consecutive contacting portions is DALPHA.
2) A first group of reed elements (GROUP A) mounted on STATIC MEMBER such that they are mechanically engaged by the contacting portions as MOVING MEMBER moves. The reed elements generating a unique combination of sound tones in response to transient contact with the contacting portion. The GROUP A reed elements further positioned such that their sound tones appear and decay substantially in unison, the appearance and decay event to be referred to as AMTE (GROUP A multi-tone event).
3) A second group of reed elements (GROUP B) mounted on STATIC MEMBER such that they are mechanically engaged by the contacting portions as MOVING MEMBER moves. The reed elements generating a unique combination of sound tones in response to transient contact with the contacting portion. The GROUP B reed elements positioned such that their sound tones appear and decay substantially in unison, the appearance and decay event to be referred to as BMTE (GROUP B multi-tone event). The GROUP B reed elements further positioned as follows:
   a. For a linear JOINT, the distance between GROUP A and GROUP B, D_AB, is: D_AB=M*DX+Y, where M is any integer and Y is a value larger than zero and smaller than DX/2.
   b. For a rotational JOINT, the angle between GROUP A and GROUP B relative to the center of rotation is: A_AB=M*DALPHA+Y, where M is any integer and Y is an angle larger than zero and smaller than DALPHA/2 degrees.

In this embodiment, the PSC pattern is an AMTE followed, after some time, by a BMTE and an NSC pattern is a BMTE followed, after some time by an AMTE.

In embodiments, means for generating IC may include:
1) Q mechanical contacting portions
2) For each mechanical contacting portion K, a corresponding group of reed elements (GROUP CK) mounted on STATIC MEMBER such that it is mechanically engaged by the contacting portion when MOVING MEMBER crosses the respective position or angle INDEX_POS(K). The reed elements in each group generating unique sound tone combinations in response to transient contact with the contacting portion. The reed elements in a group positioned such that their sound tones appear and decay substantially in unison, the appearance and decay event to be referred to as CMTE (GROUP C multi-tone event). The CMTE constituting the IC pattern.
In this embodiment, the means for detecting PSC, NSC and IC patterns is MEANS FOR DETECTING A MULTI-TONE EVENT described below.

In an embodiment for a rotational position detection system, the means for generating the PSC may include:
1) A member A with a plurality of mechanical contacting portions.
2) Means for selectively coupling member A to ROTATING MEMBER such that when ROTATING MEMBER rotates in the clock-wise direction, member A rotates substantially in tandem with it, whereas when ROTATING MEMBER rotates in the counter-clock-wise direction, member A remains substantially static and does not rotate.
3) One or more reed elements (GROUP A) mounted on STATIC MEMBER such that they are mechanically engaged by the contacting portions of member A as it rotates. The reed elements generating a unique combination of sound tones in response to transient contact with the contacting portion. The GROUP A reed elements further positioned such that their sound tones appear and decay substantially in unison, the appearance and decay event to be referred to as AMTE (group A multi-tone event). The AMTE constituting the PSC.

Means for generating the NSC may include:

A member B with a plurality of mechanical contacting portions.
1) Means for selectively coupling member B to ROTATING MEMBER such that when ROTATING MEMBER rotates in the counter-clock-wise direction, member B rotates substantially in tandem with it, whereas when ROTATING MEMBER rotates in the clock-wise direction, member B remains substantially static and does not rotate.
2) One or more reed elements (GROUP B) mounted on STATIC MEMBER such that they are mechanically engaged by the contacting portions of member B as it rotates. The reed elements generating a unique combination of sound tones in response to transient contact with the contacting portion. The GROUP B reed elements positioned such that their sound tones appear and decay substantially in unison, the appearance and decay event to be referred to as BMTE (group B multi-tone event). The BMTE constituting the NSC.

Means for generating IC may include:
1) Q mechanical contacting portions associated with ROTATING MEMBER.
2) For each mechanical contacting portion K, a corresponding group of reed elements (GROUP CK) mounted on STATIC MEMBER such that it is mechanically engaged by the contacting portion when ROTATING MEMBER crosses the respective position or angle INDEX_POS(K). The reed elements in each group generating unique sound tone combinations in response to transient contact with the contacting portion. The reed elements in a group positioned such that their sound tones appear and decay substantially in unison, the appearance and decay event to be referred to as CMTE (GROUP C multi-tone event). The CMTE constituting the IC pattern.

The selective coupling means includes frictional force between ROTATING MEMBER and members A and B and a ratchet mechanism allowing member A to move substantially only in the clock-wise direction and member B to move substantially only in the counter-clock-wise direction.

In an embodiment, the means for detecting PSC, NSC and IC patterns is MEANS FOR DETECTING A MULTI-TONE EVENT described below. In order for the PSC, NSC and IC pattern detection means to be able to robustly detect the pattern, the multi-tone events must be of sufficient temporal duration. When MOVING MEMBER's angular velocity is high, a mechanical contacting portion might make premature contact with an excited group of reed elements, thereby dampening their vibration and leading to duration of the multi-tone event to be insufficiently long. Defining MAX_V to be the largest velocity that the JOINT is required to support, the larger MAX_V is, the larger the DX must be and, consequently, the lower the resolution is. This embodiment addresses this problem, allowing a U-fold increase in resolution without requiring a substantial increase in the diameter or length of JOINT.

Means for generating PSC and NSC include:
1) A plurality of mechanical contacting portions associated with MOVING MEMBER having equal and known distance between consecutive contacting portions. The distance to be referred to as DX. For a rotary Joint, the angle between the center of rotation of ROTATING MEMBER and any two consecutive contacting portions is DALPHA.
2) A group of reed elements (GROUP A) mounted on STATIC MEMBER such that they are mechanically engaged by the contacting portions as MOVING MEMBER moves. The reed elements generating a unique combination of sound tones in response to transient contact with the contacting portion. The GROUP A reed elements further positioned such that their sound tones appear and decay substantially in unison, the appearance and decay event to be referred to as AMTE (GROUP A multi-tone event).
3) The GROUP A of reeds is duplicated U times such that, rather than one group of reeds generating a specific (unique) combination of tones, there are U groups, each of which generating the same combination of tones. The U groups positioned such that
   a. For a linear JOINT, each group is positioned such that it is engaged by a contact portion at a different position POS_A, where POS_A(W)=W*DX/U+DX*J. W being the index of the group (an integer from 1 to U) and J being an arbitrary integer.
   b. For a rotational JOINT, each group is positioned such that it is engaged by a contact portion at a different angle ANG_A, where ANG_A(W)=W*DALPHA/U+DALPHA*J. W being the index of the group (an integer from 1 to U) and J being an arbitrary integer.
4) A second group of reed elements (GROUP B) mounted on STATIC MEMBER such that they are mechanically engaged by the contacting portions as MOVING MEMBER moves. The reed elements generating a unique combination of sound tones in response to transient contact with the contacting portion. The GROUP B reed elements further positioned such that their sound tones appear and decay substantially in unison, the appearance and decay event to be referred to as BMTE (GROUP B multi-tone event).
5) The GROUP B of reeds is duplicated U times such that there are U groups, each of which generating the same combination of tones. The U groups positioned such that duplicate of GROUP A there is a corresponding duplicate of GROUP B such that
   c. For a linear JOINT, the distance between the GROUP A duplicate and the corresponding GROUP B duplicate is M*DX+Y. M being an arbitrary integer and Y being a distance larger than zero and smaller than DX/2.
   d. For a rotational JOINT, the angle, relative to the center of rotation, between the GROUP A duplicate and the corresponding GROUP B duplicate is: M*DALPHA+Y, where M is an arbitrary integer and Y is an angle larger than zero and smaller than DALPHA/2 degrees.

In this embodiment, the PSC pattern is an AMTE followed, after some time, by a BMTE and an NSC pattern is a BMTE followed, after some time by an AMTE. Also, STEP_SIZE_P and STEP_SIZE_N in this embodiment are smaller by a factor of U+1, meaning that the resolution has gone up by a corresponding factor.

Means for generating IC may include:
1) Q mechanical contacting portions
2) For each mechanical contacting portion K, a corresponding group of reed elements (GROUP CK) mounted on STATIC MEMBER such that it is mechanically engaged by the contacting portion when MOVING MEMBER crosses the respective position or angle INDEX_POS(K). The reed elements in each group generating unique sound tone combinations in response to transient contact with the contacting portion. The reed elements in a group positioned such that their sound tones appear and decay substantially in unison, the appearance and decay event to be referred to as CMTE (GROUP C multi-tone event). The CMTE constituting the IC pattern.

In embodiments, the generated sound may be a decaying multi-tone consisting of a superposition of one or more different tones, appearing substantially at the same time and decaying substantially in unison over a known duration of time. The pattern detection means may be a set of digital filters, each tuned to detect the presence of one of the tones (see FIG. 2). When a tone is detected over a sufficient amount of time is the tone considered to be active. When all tones of a known unique multi-tone COMBINATION have been detected, a multi-tone event considered to be detected.

In embodiments, each of the digital filters for detecting a specific tone may be a correlator that correlates incoming sound with the expected signal over a predetermined period of time coupled with a threshold mechanism. The threshold mechanism may binarize the correlator output so that only if the correlation is sufficiently strong is the tone considered to be detected.

In embodiments, each of the digital filters for detecting a specific tone may be a bandpass filter coupled with an amplitude threshold mechanism and a time-threshold mechanism. The amplitude threshold mechanism outputting a logical ‘1’ only when filter output exceeds a predefined amplitude, the time-threshold mechanism outputting a logical ‘1’ pulse only when the amplitude-threshold-mechanism-output is logical ‘1’ over a minimum predefined duration of time.

By way of example for a dual-tone position detection system, suppose the tones used are in the range of 5 KHz to 10 KHz with 100 Hz increments, i.e. 5000 Hz, 5100 Hz, . . . 9900 Hz, 10,000 Hz. In this case, 51 different tones are used and therefore 51 different digital filters will be applied in parallel to the received sound. Further, suppose the known decay time of the tones is 10 ms (the time in which the sound is guaranteed to be significantly above the detection threshold). So, a specific tone is detected only when the digital filter output is asserted continuously over a 10 ms period. In an embodiment, the position detection system may include:
1) One or more JOINTs, each comprising two mechanical members capable of moving one relative to the other, either linearly or rotationally. One of the members to be referred to as STATIC MEMBER and the other as MOVING MEMBER or ROTATING MEMBER.
2) For each JOINT, means for generating a vibration or a sequence of vibrations with substantially known attributes in response to incremental changes of known magnitude in the position of MOVING MEMBER with respect to STATIC MEMBER. The vibration or sequence of vibrations differing for different directions of motion. The vibration or sequence of vibrations to be referred to as PSC (Positive Step Code) for POSITIVE DIRECTION motion (POSITIVE being pre-defined for each JOINT) and NSC (Negative Step Code) for NEGATIVE DIRECTION motion (NEGATIVE also pre-defined for each JOINT). The known distance or angle, to be referred to as STEP_SIZE_P for POSITIVE DIRECTION motion and STEP_SIZE_N for NEGATIVE DIRECTION motion. Both PSC and NSC being unique to the JOINT.
3) For each JOINT, means for generating a vibration or sequence of vibrations with substantially known attributes, the generation done in response to MOVING MEMBER crossing one or more predefined positions or angles relative to STATIC MEMBER. The predefined positions or angles to be referred to as INDEX_POS(K), where K is an index in the range of 1 and Q, Q being the number of the positions or angles. The vibration or sequence of vibrations to be referred to as IC(K) (Index Code of K). Each of the IC(K) being unique.
4) A computing device including:
   a. A processing unit and associated electronics capable of executing code
   b. Wireless or wired means for communicating with an external device
   c. Means for code executing on the processing unit to access information arriving from the external device.
5) A vibration sensor with wireless or wired means for connecting to the computing device and transferring vibration data to the computing device. The sensor situated such that it senses the vibrations or sequence of vibrations.
6) Code executing on VDD that approximates, for a JOINT L, the accumulated travel of MOVING MEMBER relative to STATIC MEMBER that has taken place from a time T0, including
   a. Means for resetting two variables, P and N, to 0, at time T0.
   b. Means for detecting PSC, NSC and IC patterns of the JOINT L in received vibration data.
   c. Means for incrementing P by STEP_SIZE_P upon detection of a PSC pattern of JOINT L in the received vibration data, where STEP_SIZE_P is the step size for JOINT L in the POSITIVE DIRECTION,
   d. Means for incrementing N by STEP_SIZE_N upon detection of a NSC pattern of JOINT L in the received vibration data, where STEP_SIZE_N is the step size for JOINT L in the NEGATIVE DIRECTION,
   e. Means for calculating the value Z=P−N, where Z approximates the accumulated travel for JOINT L that has taken place since T0.
7) Means for code executing on VDD to approximate, for a JOINT L, the absolute position of MOVING MEMBER relative to STATIC MEMBER including
   a. Means for detecting PSC, NSC and IC patterns of the JOINT L on received vibration data.
   b. Means for resetting two variables P and N to 0 in response to detection of an IC pattern K of JOINT L
   c. Means for incrementing P by STEP_SIZE_P upon detection of a PSC pattern of JOINT L in the received vibration data, where STEP_SIZE_P is the step size for JOINT L in the POSITIVE DIRECTION,
   d. Means for incrementing N by STEP_SIZE_N upon detection of a NSC pattern of JOINT L in the received vibration data, where STEP_SIZE_N is the step size for JOINT L in the NEGATIVE DIRECTION,
   e. Means for calculating ABS=P−N+INDEX_POS(K), where ABS is the approximation of the absolute position of JOINT L.

The following are additional enumerated embodiments according to the present disclosure.

A first embodiment, which is a method for determining the relative positions of first and second members of a joint, wherein the joint includes one or more vibratory elements and one or more excitatory elements, the method comprising changing the relative position of the first and second members of the joint to initiate a first vibration signal with a first characteristic frequency spectrum from a first pair of a vibratory element and an excitatory element; detecting the first vibration signal with the first characteristic frequency spectrum using a vibration-detecting device, the first vibration signal corresponding to a first relative position between the first and second members of the joint; and further changing the relative position of the first and second members of the joint to excite a second vibration signal with the first characteristic frequency spectrum from a second pair of a vibratory element and an excitatory element, the second vibration signal corresponding to a second relative position of the first and second members of the joint; detecting the second vibration signal, wherein each repetition of a vibration signal with the first characteristic frequency spectrum corresponds to a known increment of relative position of the first and second members of the joint so that by counting the number of vibration signals, the relative change in position of the first and second members of the joint can be determined.

A second embodiment, which is the method of the first embodiment, wherein further changing the relative position of the first and second members of the joint comprises further changing the relative position of the first and second members of the joint to excite the second vibration signal with the first characteristic frequency spectrum from a second pair of a vibratory element and an excitatory element that includes either the same vibratory element or the same excitatory element as included in the first pair of vibratory element and an excitatory element.

A third embodiment, which is the method of the second embodiment, wherein further changing the relative position of the first and second members of the joint comprises further changing the relative position of the first and second members of the joint to excite the second vibration signal with the first characteristic frequency spectrum from a second pair of a vibratory element and an excitatory element that includes the same vibratory element as included in the first pair of vibratory element and an excitatory element.

A fourth embodiment, which is the method of the second embodiment, wherein further changing the relative position of the first and second members of the joint comprises further changing the relative position of the first and second members of the joint to excite the second vibration signal with the first characteristic frequency spectrum from a second pair of a vibratory element and an excitatory element that includes the same excitatory element as included in the first pair of vibratory element and an excitatory element.

A fifth embodiment, which is the method of the first embodiment, wherein each of the vibratory elements comprises a reed.

A sixth embodiment, which is the method of the first embodiment, wherein the joint is a rotary joint, and changing the relative positions of the first and second members of the joint comprises rotating one of the direct and second members with respect the other member.

A seventh embodiment, which is the method of the first embodiment, wherein the joint is a linear joint, and changing the relative positions of the first and second members of the joint comprises translating one of the direct and second members with respect the other member.

An eighth embodiment, which is the method of the third embodiment, wherein the first characteristic frequency spectrum is determined by the design parameters of the vibratory element and the excitatory element.

A ninth embodiment, which is the method of the fifth embodiment, wherein the first characteristic frequency spectrum of the reeds is determined by the types of materials in the reeds, and the lengths and thicknesses of the reeds.

A tenth embodiment, which is the method of the first embodiment, wherein the vibration-detecting device is configured to receive instructions for data processing from a non-transitory computer-readable storage medium.

An eleventh embodiment, which is the method of the first embodiment, further comprising amplification devices configured to amplify the vibration signals.

A twelfth embodiment, which is a method for detecting one or more degrees of freedom for the relative positions between first and second members of a multiplicity of joints in a system, wherein each degree of freedom comprises a single position-sensitive vibration source, the method comprising changing the relative positions between the first and second members of one or more joints in the multiplicity of joints to excite vibration signals from the position-sensitive vibration sources; detecting a mixture of vibration signals using a vibration-detecting device; separating the vibration signals from the mixture of vibration signals, wherein each separated vibration signal corresponds to a single degree of freedom; processing the separated vibration signals for each degree of freedom to monitor relative motions of each joint in the multiplicity of j oints; and repeating the steps of detecting, separating and processing while relative motion between the first and second members of joints from the multiplicity of joints continues.

A thirteenth embodiment, which is a device having first and second members capable of moving relative to each other, the device able to determine the relative motion of the at least two parts, comprising a first member having thereon a set of one or more excitatory elements; a second member having thereon a set of one or more vibratory elements, each of the vibratory elements constructed to vibrate with approximately the same characteristic frequency spectrum; the first and second members configured such that relative movement between the first member and the second member triggers one of the one or more excitatory elements in the set to cause one of the vibratory elements in the set to vibrate, the one or more vibratory elements vibrating with the same characteristic frequency spectrum.

A fourteenth embodiment, which is the device of the thirteenth embodiment, in which the set of one or more vibratory elements comprises a single reed; the set of one or more excitatory elements comprises multiple excitatory elements positioned around a circular perimeter; and the reed and the multiple excitatory elements are configured such that rotating one of the first and second members relative to the other causes the multiple excitatory elements to initiate vibration of the reed, each initiation of vibration of the reed corresponding to a known amount of rotational displacement.

A fifteenth embodiment, which is device of the thirteenth embodiment, in which the first member is attached to a first portion of a toy and the second member is attached to a second portion of the toy.

A sixteenth embodiment, which is the device of the thirteenth embodiment, further comprising a detector for detecting the vibration of the vibratory elements when initiated by the excitatory elements.

A seventeenth embodiment, which is the device of the sixteenth embodiment, further comprising a processor programmed to calculate from the multiple initiation of vibrations of the excitatory elements the amount of relative motion of the first member and the second member.

An eighteenth embodiment, which is a joint, comprising first and second members, wherein the first member comprises first and second reeds, wherein the second member comprises a multiplicity of teeth, wherein the multiplicity of teeth is positioned so that teeth from the multiplicity of teeth contact the first and second reeds during relative motion between the first and second members, wherein during relative motion between the first and second members, the first reed generates a first vibration signal with a first characteristic frequency spectrum induced by release of contact with a tooth in the multiplicity of teeth and the second reed generates a second vibration signal with a second characteristic frequency spectrum induced by release of contact with a tooth in the multiplicity of teeth, and wherein a timing difference between the first and second vibration signals indicates the direction of motion of the moving member.

A nineteenth embodiment, which is the joint of the eighteenth embodiment, wherein the joint is a rotary joint, and wherein the teeth in the multiplicity of teeth on the second member are equally-spaced around a circumference of the rotary joint.

A twentieth embodiment, which is the joint of the eighteenth embodiment, wherein the joint is a linear joint, and wherein the teeth in the multiplicity of teeth on the second member are equally-spaced along a portion of the length of the linear joint.

A twenty-first embodiment, which is the joint of the eighteenth embodiment, wherein the second member further comprises a single tooth, wherein the first member further comprises a third reed, wherein during relative motion between the first and second members, the third reed generates a third vibration signal with a third characteristic frequency spectrum induced by the release of contact from the single tooth, and wherein the third vibration signal indicates a home position for the second member.

A twenty-second embodiment, which is the joint of the twenty-first embodiment, wherein the characteristic frequency spectra are unique.

A twenty-third embodiment, which is the joint of the twenty-second embodiment, wherein the characteristic frequency spectra are determined by the design parameters of the first, second and third reeds, including the types of materials, the lengths, and the thicknesses of the first, second and third reeds.

A twenty-fourth embodiment, which is the method of the twelfth embodiment, wherein each position-sensitive vibration source comprises a set of one or more vibratory elements, each of the vibratory elements constructed to vibrate with approximately the same characteristic frequency spectrum, and wherein the characteristic frequency spectrum of each set of one or more vibratory elements differs from the characteristic frequency spectra of other position-sensitive vibration sources; a set of one or more excitatory elements; and the vibratory element and the excitatory elements are configured such that rotating or linearly moving one of the first and second members relative to the other causes the multiple excitatory elements to initiate vibration of the reed, each initiation of vibration of the reed corresponding to a known amount of rotational or linear displacement.

A twenty-fifth embodiment, which is the method of the twenty-fourth embodiment, wherein each of the vibratory elements comprises a reed.

A twenty-sixth embodiment, which is the method of the twenty-fifth embodiment, wherein the characteristic frequency spectrum of each reed is determined by the types of materials in the reed, and the length and thickness of the reed.

A twenty-seventh embodiment, which is the method of the twelfth embodiment, wherein the vibration-detecting device further comprises a processor programmed to calculate from the multiple initiation of vibrations of the excitatory elements the amount of relative motion of the first and second members of the multiplicity of joints in the system.

A twenty-eighth embodiment, which is the method of the twelfth embodiment, wherein the vibration-detecting device is configured to receive instructions for data processing from a non-transitory computer-readable storage medium.

A twenty-ninth embodiment, which is the method of the twelfth embodiment, further comprising amplification devices configured to amplify the vibration signals.

### CONCLUSION

Although the present invention and its advantages have been described in detail, it should be understood that various changes, substitutions and alterations can be made to the embodiments described herein without departing from the scope of the disclosure as defined by the appended claims. Moreover, the scope of the disclosure is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Many variations and modifications of the invention disclosed herein are possible, and alternative embodiments that result from combining, integrating, and/or omitting features of the embodiments disclosed herein are also within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, 50 percent, 51 percent, 52 percent, 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of the term “may” to introduce features of embodiments of the disclosure (e.g., “In an embodiment, the widget may be connected to a cog,”) is intended to mean that embodiments reciting the features are considered to be within the scope of the invention and such embodiments shall be construed as being positively recited by the specification. However, use of the term “may” to introduce features of embodiments is not an indication that embodiments failing to recite the features are considered outside the scope of the invention. Further, although various features of embodiments are described in plural form (e.g., attachment surfaces, localized attractive sites, etc.), embodiments having single instances of the features (e.g., one attachment surface, one localized attractive site, etc.), alone or in combination with single or plural instances of other features, are also contemplated to be within the scope of the invention unless explicitly indicated otherwise. Use of broader terms such as “comprises,” “includes,” “having,” etc. should be understood to provide support for narrower terms such as “consisting of” “consisting essentially of” “comprised substantially of” etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the embodiments of the present invention. The discussion of a reference in the Detailed Description of the Embodiments is not an admission that it is prior art to the present invention, especially any reference that may have a publication date after the priority date of this application.

1. A method for determining the relative positions of first and second members of a joint, wherein the joint includes one or more vibratory elements and one or more excitatory elements, the method comprising:
changing the relative position of the first and second members of the joint to initiate a first vibration signal with a first characteristic frequency spectrum from a first pair of a vibratory element and an excitatory element;
detecting the first vibration signal with the first characteristic frequency spectrum using a vibration-detecting device, the first vibration signal corresponding to a first relative position between the first and second members of the joint; and
further changing the relative position of the first and second members of the joint to excite a second vibration signal with the first characteristic frequency spectrum from a second pair of a vibratory element and an excitatory element, the second vibration signal corresponding to a second relative position of the first and second members of the joint;
detecting the second vibration signal,
wherein each repetition of a vibration signal with the first characteristic frequency spectrum corresponds to a known increment of relative position of the first and second members of the joint so that by counting the number of vibration signals, the relative change in position of the first and second members of the joint can be determined.

2. The method of claim 1, wherein further changing the relative position of the first and second members of the joint comprises further changing the relative position of the first and second members of the joint to excite the second vibration signal with the first characteristic frequency spectrum from a second pair of a vibratory element and an excitatory element that includes either the same vibratory element or the same excitatory element as included in the first pair of vibratory element and an excitatory element.

3. The method of claim 2, wherein further changing the relative position of the first and second members of the joint comprises further changing the relative position of the first and second members of the joint to excite the second vibration signal with the first characteristic frequency spectrum from a second pair of a vibratory element and an excitatory element that includes the same vibratory element as included in the first pair of vibratory element and an excitatory element.

4. The method of claim 2, wherein further changing the relative position of the first and second members of the joint comprises further changing the relative position of the first and second members of the joint to excite the second vibration signal with the first characteristic frequency spectrum from a second pair of a vibratory element and an excitatory element that includes the same excitatory element as included in the first pair of vibratory element and an excitatory element.

5. The method of claim 1, wherein each of the vibratory elements comprises a reed.

6. The method of claim 1, wherein the joint is a rotary joint, and changing the relative positions of the first and second members of the joint comprises rotating one of the direct and second members with respect the other member.

7. The method of claim 1, wherein the joint is a linear joint, and changing the relative positions of the first and second members of the joint comprises translating one of the direct and second members with respect the other member.

8. The method of claim 3, wherein the first characteristic frequency spectrum is determined by the design parameters of the vibratory element and the excitatory element.

9. The method of claim 5, wherein the first characteristic frequency spectrum of the reeds is determined by the types of materials in the reeds, and the lengths and thicknesses of the reeds.

10. The method of claim 1, wherein the vibration-detecting device is configured to receive instructions for data processing from a non-transitory computer-readable storage medium.

11. The method of claim 1, further comprising amplification devices configured to amplify the vibration signals.

12. (canceled)

13. A device having first and second members capable of moving relative to each other, the device able to determine the relative motion of the at least two parts, comprising:
a first member having thereon a set of one or more excitatory elements;
a second member having thereon a set of one or more vibratory elements, each of the vibratory elements constructed to vibrate with approximately the same characteristic frequency spectrum;
the first and second members configured such that relative movement between the first member and the second member triggers one of the one or more excitatory elements in the set to cause one of the vibratory elements in the set to vibrate, the one or more vibratory elements vibrating with the same characteristic frequency spectrum.

14. The device of claim 13 in which:
the set of one or more vibratory elements comprises a single reed;
the set of one or more excitatory elements comprises multiple excitatory elements positioned around a circular perimeter; and
the reed and the multiple excitatory elements are configured such that rotating one of the first and second members relative to the other causes the multiple excitatory elements to initiate vibration of the reed, each initiation of vibration of the reed corresponding to a known amount of rotational displacement.

15. The device of claim 13 in which the first member is attached to a first portion of a toy and the second member is attached to a second portion of the toy.

16. The device of claim 13 further comprising a detector for detecting the vibration of the vibratory elements when initiated by the excitatory elements.

17. The device of claim 16 further comprising a processor programmed to calculate from the multiple initiation of vibrations of the excitatory elements the amount of relative motion of the first member and the second member.

18. A joint, comprising first and second members, wherein the first member comprises first and second reeds, wherein the second member comprises a multiplicity of teeth, wherein the multiplicity of teeth is positioned so that teeth from the multiplicity of teeth contact the first and second reeds during relative motion between the first and second members, wherein during relative motion between the first and second members, the first reed generates a first vibration signal with a first characteristic frequency spectrum induced by release of contact with a tooth in the multiplicity of teeth and the second reed generates a second vibration signal with a second characteristic frequency spectrum induced by release of contact with a tooth in the multiplicity of teeth, and wherein a timing difference between the first and second vibration signals indicates the direction of motion of the moving member.

19. The joint of claim 18, wherein the joint is a rotary joint, and wherein the teeth in the multiplicity of teeth on the second member are equally-spaced around a circumference of the rotary joint.

20. The joint of claim 18, wherein the joint is a linear joint, and wherein the teeth in the multiplicity of teeth on the second member are equally-spaced along a portion of the length of the linear joint.

21. The joint of claim 18, wherein the second member further comprises a single tooth, wherein the first member further comprises a third reed, wherein during relative motion between the first and second members, the third reed generates a third vibration signal with a third characteristic frequency spectrum induced by the release of contact from the single tooth, and wherein the third vibration signal indicates a home position for the second member.

22. The joint of claim 21, wherein the characteristic frequency spectra are unique.

23. The joint of claim 22, wherein the characteristic frequency spectra are determined by the design parameters of the first, second and third reeds, including the types of materials, the lengths, and the thicknesses of the first, second and third reeds.

24-29. (canceled)
